(19) United States
(12) Patent Application Publication
(10) Pub. No.: US 2014/0056524 A1
(43) Pub. Date: Feb. 27, 2014

(54) IMAGE PROCESSING DEVICE, IMAGE PROCESSING METHOD, AND PROGRAM

(71) Applicant: Sony Corporation, Tokyo (JP)

(72) Inventors: KENSUKE ISHII, Tokyo (JP); SATOSHI SUZUKI, Tokyo (JP)

(73) Assignee: Sony Corporation, Tokyo (JP)

(21) Appl. No.: 13/964,350

(22) Filed: Aug. 12, 2013

(30) Foreign Application Priority Data
Aug. 22, 2012 (JP) 2012-183118

(51) Int. Cl. G06T 7/00

(52) U.S. Cl. CPC G06T 7/0022
USPC 382/190; 382/284; 382/233

(57) ABSTRACT

There is provided an image processing device including an image processing unit configured to divide an input image, to generate a plurality of divided images, and configured to generate an output image which includes the divided images, and a communication unit configured to output the output image to a second image processing device adapted to be able to restore the input image by combining the divided images.

### BACKGROUND

The present disclosure relates to an image processing device, an image processing method, and a program.

Techniques, which divide an input image to generate divided images, encode the divided images to generate encoding information, and output the encoding information to video equipment, are disclosed in Japanese Unexamined Patent Application Publication Nos. 2004-120499, 2011-181980, and Hei 10-234043. The video equipment decodes encoding information to restore the divided images and combines the divided images to restore the input image. In addition, Japanese Unexamined Patent Application Publication No. Hei 9-65111 discloses a technique for encoding an input image in which a predetermined position is set as high resolution and outputting the encoded input image to video equipment. The video equipment decodes the encoded input image to restore the input image.

### SUMMARY

Therefore, video equipment is necessary to decode the encoding information in order to restore an input image. For this reason, excessive amounts of time and efforts are necessary in order for video equipment to restore an input image. Thus, it is desirable to provide a technology in which video equipment can easily restore an input image.

According to an embodiment of the present disclosure, there is provided an image processing device including an image processing unit configured to divide an input image, to generate a plurality of divided images, and configured to generate an output image which includes the divided images, and a communication unit configured to output the output image to a second image processing device adapted to be able to restore the input image by combining the divided images.

According to an embodiment of the present disclosure, there is provided an image processing device including a communication unit configured to divide an input image, to generate a plurality of divided images, to incorporate the divided images, and to obtain the output image from a second image processing device, the second image processing device being adapted to generate the output image with a first resolution, and an image processing unit to extract the divided images from the output image, to combine the divided images, and to restore the input image.

According to an embodiment of the present disclosure, there is provided an image processing method including dividing an input image to generate a plurality of divided images and generating an output image which includes the divided images, and outputting the output image to a second image processing device adapted to be able to restore the input image by combining the divided images.

According to an embodiment of the present disclosure, there is provided an image processing method including dividing an input image to generate a plurality of divided images and obtaining an output image from a second image processing device adapted to generate the output image which includes the divided images, and extracting the divided images from the output image and combining the divided images to restore the input image.

According to an embodiment of the present disclosure, there is provided a program that causes a computer to implement an image processing function of dividing an input image to generate a plurality of divided images and generating an output image which includes the divided images, and a communication function of outputting the output image to a second image processing device adapted to be able to restore the input image by combining the divided images.

According to an embodiment of the present disclosure, there is provided a program that causes a computer to implement a communication function of dividing an input image to generate a plurality of divided images and obtaining an output image from a second image processing device adapted to generate the output image which includes the divided images, and an image processing function of extracting the divided images from the output image and combining the divided images to restore the input image.

According to the embodiments of the present disclosure, the image processing device which receives the output image including the divided images can restore the input image by combining the divided images.

As described above, according to the embodiments of the present disclosure, the image processing device which receives the output image including the divided images can combine the divided images without decoding the divided images. Thus, the image processing device can easily restore the input image.

### BRIEF DESCRIPTION OF THE DRAWINGS

FIG. 1 is a block diagram illustrating a configuration of an image processing system according to an embodiment of the present disclosure;

FIG. 2 is a diagram illustrating an example of a 4K original image and a reduced image;

FIG. 3 is a diagram illustrating an example of division of a 4K original image;

FIG. 4 is a diagram illustrating an example of superimposition position of addition control information;

FIG. 5 is a diagram illustrating an example of first addition control information;

FIG. 6 is a diagram illustrating an example of second addition control information;

FIG. 7 is a diagram for explaining the content of information indicated by the second addition control information;

FIG. 8 is a diagram illustrating an example of a description image and divided description images;

FIG. 9 is a diagram illustrating an example of a blank image;

FIG. 10 is a diagram illustrating an exemplary display of a description image;

FIG. 11 is a diagram illustrating an exemplary display of a blank image;

FIG. 12 is a diagram illustrating an exemplary generation of a 4K restoration image;

FIG. 13 is a timing chart illustrating an overview of a process performed by the image processing system;

FIG. 14 is a timing chart illustrating an overview of a process performed by the image processing system;

FIG. 15 is a timing chart illustrating an overview of a process performed by the image processing system;

FIG. 16 is a diagram illustrating an example of first addition control information corresponding to photo 1 and photo 2;

FIG. 17 is a sequence diagram illustrating processing steps that are performed by an image processing device and video equipment; and

FIG. 18 is a sequence diagram illustrating processing steps that are performed by the image processing device and video equipment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order:

1. Discussion of Background Art

2. Overall Configuration

3. Configuration of Image Processing Device
3-1. Generation of 4K Original Image and Reduced Image
3-2. Generation of Divided Images
3-3. Superimposed Position and Configuration of Addition Control Information (Additional Control Signal)
3-4. Authentication Process (Authentication Test)
3-5. Processing relevant to SPD Infoframe

4. Configuration of Video Equipment

5. Overview of Process performed by Image Processing System

6. Processing performed by Image Processing System

<1. Discussion of Background Art>

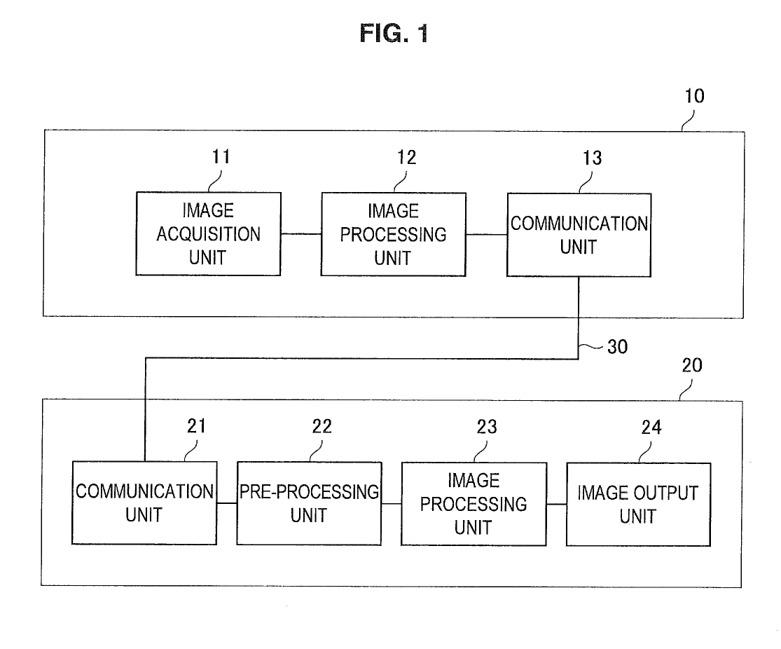

The inventors of the present disclosure have conducted studies on the background art related to the present exemplary embodiment and have conceived an image progressing system according to the embodiment (see FIG. 1). Thus, the background art studied by the inventors will now be described.

There has been proposed video equipment with high resolution, in particular, 4K (3840×2160 pixels) resolution. Specifically, video equipment which obtains a 4K image via the high definition multimedia interface (HDMI) 1.4a or a proprietary interface and displays the 4K image has been proposed. However, a 4K image that can be displayed by this video equipment is limited to an image obtained by video equipment via such an interface and a still image (e.g., a JPEG image) which is decoded and scaled for 4K resolution.

On the other hand, video equipment with a built-in decoder has been proposed. Such video equipment obtains encoding information (information obtained by encoding a 4K image) from a communication network and decodes the obtained encoding information therein, and thereby restoring and displaying the 4K image.

Thus, according to the above-described video equipment, the type of image to be displayed is quite limited. In addition, the video equipment of the latter type (video equipment with a built-in decoder) is necessary to decode encoding information in order to restore the 4K image. Because the 4K image has a large amount of information, the encoding information also has a large amount of information. Thus, excessive amounts of time and efforts are necessary to restore the 4K image in the video equipment with a built-in decoder described above. In addition, enormous development costs are necessary to develop a decoder for video equipment.

On the other hand, techniques which divide an input image to generate divided images, encode the divided images to generate encoding information, and output the encoding information to video equipment are disclosed in Japanese Unexamined Patent Application Publication Nos. 2004-120499, 2011-181980, and Hei 10-234043. The video equipment decodes the encoding information to restore the divided images and combines the divided images to restore the input image.

In addition, Japanese Unexamined Patent Application Publication No. Hei 9-65111 discloses a technique for encoding an input image in which a predetermined position is set as high resolution and outputting the encoded input image to video equipment. The video equipment decodes the encoded input image to restore the input image. However, in the techniques described in Japanese Unexamined Patent Application Publication Nos. 2004-120499, 2011-181980, Hei 10-234043, and Hei 9-65111, the video equipment is necessary to be provided with a decoder. Thus, when the 4K image is applied to these techniques, excessive amounts of time and efforts will be necessary to restore the 4K image in the video equipment.

On the other hand, there has been proposed an image processing device which is compatible with an output of a 2K image (an image of 1920×1080 pixels) such as some game consoles and includes a high performance decoder. In the decoder included in the image processing device, a still image which is represented by a JPEG or the like can be decoded faster than the decoder included in the video equipment. Further, the image processing device may include, for example, a user interface corresponding to an input operation using a controller, thus the user interface will be sophisticated. In addition, enormous development costs will be necessary in order for the video equipment to be provided with such an interface.

The present inventors have conducted extensive studies on the video equipment and image processing device described above and have conceived the image processing system according to the present exemplary embodiment. The configuration of the image processing system will now be described in detail. In addition, in the present exemplary embodiment, 4K is defined herein as 3840×2160 pixels and 2K is defined as 1920×1080 pixels, but other resolution sizes may be used. For example, 4K may be defined as 4096×2160 pixels.

<2. Overall Configuration>

Referring to FIG. 1, an overall configuration of the image processing system will now be described. The image processing system includes an image processing device 10, video equipment (image processing device) 20, and a HDMI cable 30. In other words, the image processing system does not contain communication functions such as HDMI-CEC and communication networks. Of course, the image processing system may contain such communication functions.

The image processing device 10 generally performs the following processes of:

(1) changing SPD Infoframe to a specific value at a predetermined timing (for example, before outputting divided images). In this process, the SPD Infoframe contains information (a device name, etc.) for specifying the image processing device 10 and is outputted to the video equipment 20.

(2) temporarily stopping the output of HDMI TMDS signal (may be also simply referred to as “TMDS signal” hereinafter) before changing the SPD Infoframe.

(3) reading EDID information from the video equipment 20 and performing a process based on the EDID information. In this process, the EDID information is information related to the properties of the video equipment 20, and, in the present exemplary embodiment, The EDID information contains information indicating whether divided images can be combined or not.

(4) generating a still image (4K original image) with 4K resolution by reserving a region for 4K resolution (3840×2160) in an internal memory (RAM, etc.) and by attaching a still image such as JPEG to the memory region.

(5) generating divided images by dividing the 4K original image expanded in the internal memory into 12 images.

(6) outputting the divided images at each interval of 2V. In this case, 1V is a time taken by a one-frame image to be outputted. For example, if the image processing device 10 has a frame rate of 60 Hz, then 1V is equal to 16.6 ms.

(7) superimposing (adding) addition control information on each of the divided images.

(8) before outputting the divided images to the video equipment 20, reducing the 4K original image to a reduced image (one image) of 2K resolution (1920×1080), and outputting the reduced image as an output image for the interval of 12V or more.

(9) when the EDID information outputted from the video equipment 20 has not been read out, generating divided images by dividing a description image in which a trigger operation necessary for initiating the generation of divided images is described, and outputting the divided images to the video equipment 20.

(10) outputting the divided images repeatedly.

In the above processes, the process (8) and subsequent processes are optional. In other words, the image processing device 10 may not perform the process (8) and subsequent processes.

On the other hand, the video equipment 20 generally performs the following processes of:

(1) temporarily stopping the reception of TMDS signal, and when the reception of TMDS signal is resumed, detecting the change in SPD Infoframe.

(2) incorporating combining-capable information indicating that the video equipment 20 is compatible with combining of divided images into the EDID information.

(3) decoding the addition control information.

(4) capturing the output images (divided images) outputted at the interval of 2V at a predetermined timing (for example, at the interval of 1V), and restoring the 4K original image.

(5) when the addition control information includes information indicating that the 4K original image is a three dimensional (3D) image, restoring at least the left-eye image as the 4K original image and outputting it as a two dimensional (2D) image.

(6) during capturing the divided images, when the reception of divided images corresponding to other 4K still image is initiated, following the capture of the divided images.

(7) when the addition control information includes information indicating that an output image is a blank image, not displaying the output image.

(8) when the addition control information includes information indicating that an output image is a reduced image, detecting a facial image from the output image and weakening a super resolution process for the color included in the facial image. Namely, the skin retouching is performed.

(9) when the addition control information includes information indicating that the 4K original image is a 3D image, performing the combining of left-eye image and right-eye image in sequence and displaying (outputting) these images as 3D still images. Namely, images with parallax are outputted.

In the above processes, the process (8) and subsequent process are optional. In other words, the video equipment 20 may not perform the process (8) and subsequent process.

<3. Configuration of Image Processing Device>

A configuration of the image processing device 10 will now be described. The image processing device 10 includes an image acquisition unit 11, an image processing unit 12, and a communication unit 13. The image processing device 10 may be a game console, and includes hardware components such as CPU, ROM, RAM, hard disk, controller, and communication device. The ROM stores a program used to allow the image processing device 10 to implement the image acquisition unit 11, the image processing unit 12, and the communication unit 13. The CPU reads the program stored in the ROM and executes it. Thus, the image acquisition unit 11, the image processing unit 12, and the communication unit 13 are implemented by these hardware components. In addition, the ROM also stores a program related to a photographic reproduction application. The hard disk stores various images (e.g., photographic images reproduced by the photographic reproduction application) in an encoded state. These photographic images have various sizes. The size of photographic images may be 4K, but other sizes such as 2K may be possible.

The image acquisition unit 11 acquires an input image (e.g., still image) which is to be displayed by the video equipment 20. Specifically, the image acquisition unit 11 acquires encoding information in which the input image is encoded and outputs it to the image processing unit 12. The image acquisition unit 11 may acquire encoding information from the above-described hard disk or acquire it over a network. The input image has various sizes. For example, the size of input image may be 4K, but other sizes such as 2K may be possible.

The image processing unit 12 mainly performs generation of a 4K original image and reduced image, generation of divided images, superimposition of addition control information, and authentication process (authentication test). Thus, these processes will be described.

(3-1. Generation of 4K Original Image and Reduced Image)

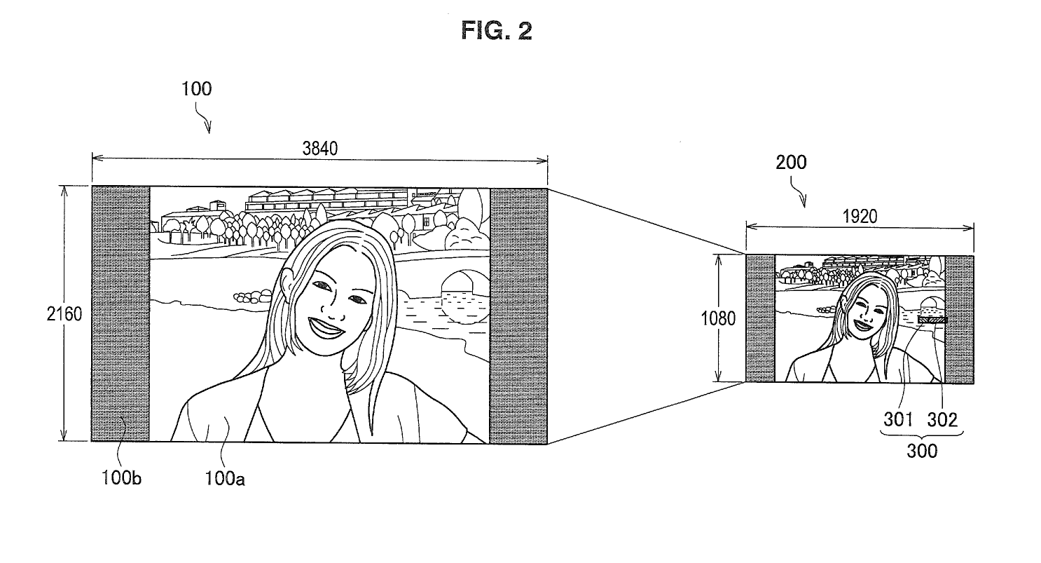

The generation of a 4K original image and reduced image will now be described with reference to FIG. 2. The image processing unit 12 restores an input image 100a by decoding the encoding information and perform scaling of the input image 100a. On the other hand, the image processing unit 12 reserves a memory region for 4K resolution. The memory region will be a total of about 23.7 MB in size if it is converted into YUV444 format (24 bits per pixel).

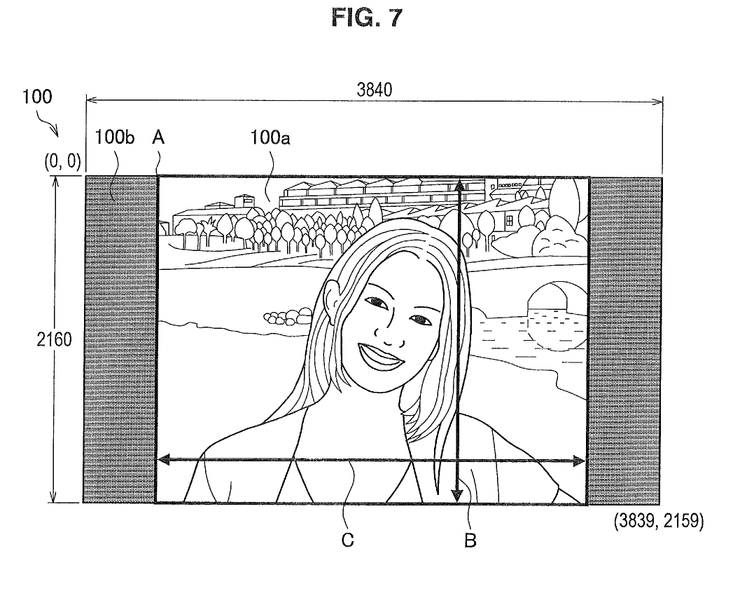

The image processing unit 12 attaches the input image 100a to any area of the memory region to generate a 4K original image 100. An area of the memory region to which the input image 100a is not attached is a marginal image 100b. The marginal image 100b is, for example, black in color. In addition, the 4K original image has various color formats including, but not particularly limited to, RGB, YCbCr444, YCbCr422, or YUV. Each pixel constituting the 4K original image 100 has the xy coordinates (see FIG. 7). The coordinates of a pixel in the upper left end are (0, 0), and the coordinates of a pixel in the lower right end are (3839, 2159). The xy coordinates that are set in the 4K original image 100 are hereinafter referred to as original image coordinates.

The image processing unit 12 generates a reduced image 200 by reducing the 4K original image to 2K. In addition, the image processing unit 12 sets the reduced image 200 as an output image, and superimposes (adds) addition control information 300 on a predetermined position of an output image. The addition control information will be described later. The image processing unit 12 outputs the output image to the communication unit 13. The communication unit 13 outputs the reduced image 200 at the interval of 12V before outputting divided images that will be described later.

(3-2. Generation of Divided Images)

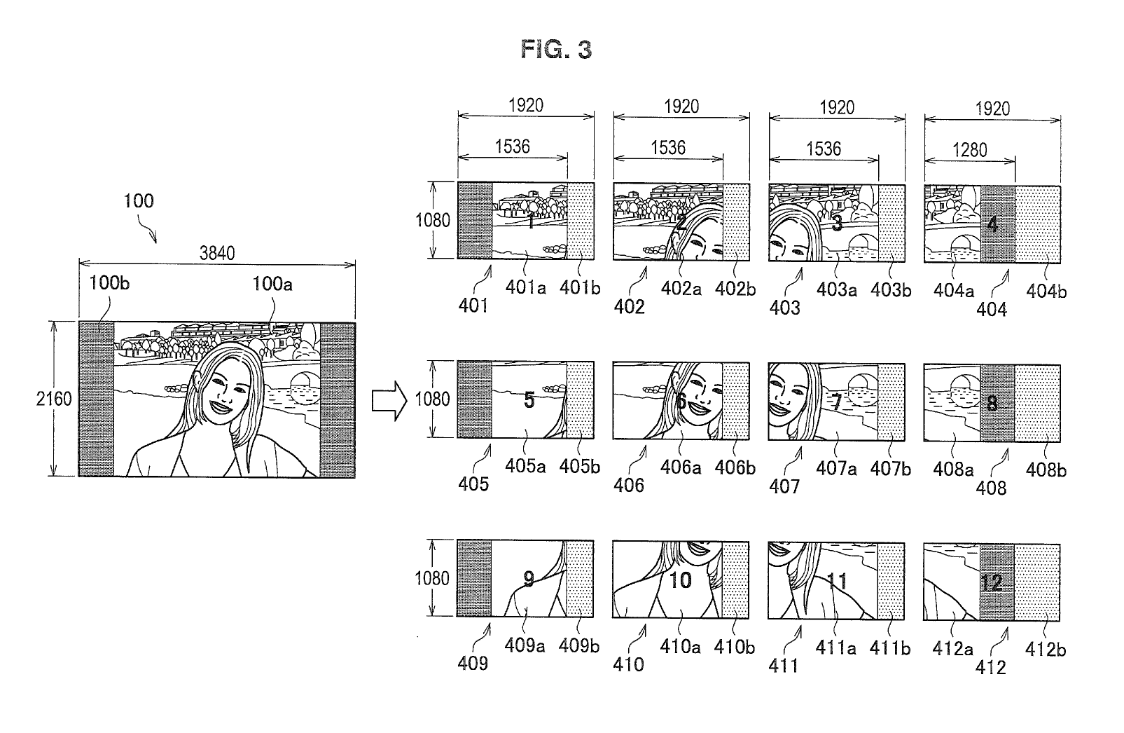

Referring to FIG. 3, the generation of divided images will be described. The image processing unit 12 generates divided images 401a to 412a by dividing the 4K original image 100 into 12 parts. The image processing unit 12 divides the 4K original image 100 so that the divided images 401a to 412a are partially overlapped with each other. Specifically, the image processing unit 12 sets a clipping start position and clipping size of each of the divided images 401a to 412a, as listed in Table 1 below. The clipping start position may be the original image coordinates of a pixel constituting the upper left end of the divided images 401a to 412a. The clipping size may be the size of the divided images 401a to 412a, and the unit of the clipping size is a pixel (picture element).

TABLE 1

| Divided Images | Clipping Start Position | Clipping Size |
|---|---|---|
| 401a | 0, 0 | 1536 × 1080 |
| 402a | 768, 0 | 1536 × 1080 |
| 403a | 1792, 0 | 1536 × 1080 |
| 404a | 2560, 0 | 1280 × 1080 |
| 405a | 0, 540 | 1536 × 1080 |
| 406a | 768, 540 | 1536 × 1080 |
| 407a | 1792, 540 | 1536 × 1080 |
| 408a | 2560, 540 | 1280 × 1080 |
| 409a | 0, 1080 | 1536 × 1080 |
| 410a | 768, 1080 | 1536 × 1080 |
| 411a | 1792, 1080 | 1536 × 1080 |
| 412a | 2560, 1080 | 1280 × 1080 |

As listed in Table 1, the divided images 404a, 408a, and 412a have different clipping sizes than others, and this is due to hardware specifications of the video equipment 20. Thus, all of the divided images may be set to have the same size depending on the specifications of the video equipment 20. The number of divided images is not limited to 12.

The image processing unit 12 reserves the memory regions for 2K resolution and attaches the divided images 401a to 412a to the respective memory regions in a left justified form, thereby generating output images 401 to 412. Each of these memory regions is approximately 6.0 MB per image if it is converted into YUV444 data format. The output images 401 to 412 are configured to include the divided images 401a to 412a and marginal images 401b to 412b, respectively. The marginal images 401b to 412b are preferably gray in color (Y=191, Cb=Cr=128) having brightness that is the least affected by the 4K original image and image processing. The marginal images 401b to 412b may have any other colors. For example, the marginal images may have black in color but its color is not limited thereto. Thus, each of the output images 401 to 412 has 2K in size (specifically, for example, 1920×1080/59.94p, or 1920×1080/50p).

The divided images 401a to 412a are partially overlapped with each other. This is because if the divided images 401a to 412a are not overlapped with each other at all, it is necessary for the video equipment 20 to use all of the divided images 401a to 412a when the 4K original image 100 is restored. On the other hand, regions outside of the divided images 401a to 412a are the marginal images 401b to 412b with black color, and thus brightness at outer edges of the divided images 401a to 412a may be blurred. Accordingly, when the video equipment 20 restores the 4K original image 100 using all of the divided images 401a to 412a, the restored 4K original image 100 may be blurred in regions at boundary portions of the divided images 401a to 412a.

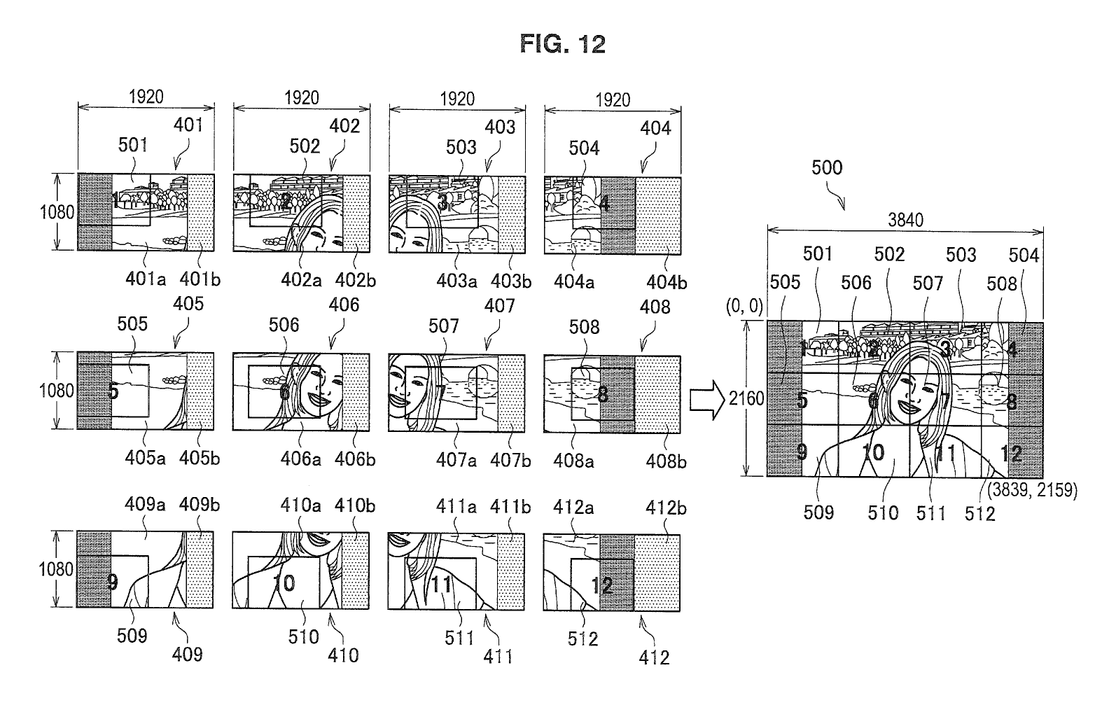

In this regard, according to the present exemplary embodiment, in the case where the divided images 401a to 412a are partially overlapped with each other, it is sufficient for the video equipment 20 to use only a portion of the divided images 401a to 412a when restoring the 4K original image 100 (see FIG. 12). In this case, areas in the vicinity of the region (captured images 501 to 512 shown in FIG. 12) being used by the divided images 401a to 412a are occupied with pixels constituting the 4K original image 100. Thus, blurring at outer edges of the captured images 501 to 512 is reduced. For this reason, when the video equipment 20 restores the 4K original image 100 using the captured images 501 to 512, the restored 4K original image 100 has less blur at the boundary portions of the captured images 501 to 512. In other words, areas near the captured images 501 to 512 serve as overlapped portions when restoring the 4K original image 100. Thus, in the present exemplary embodiment, the divided images 401a to 412a will be partially overlapped with each other.

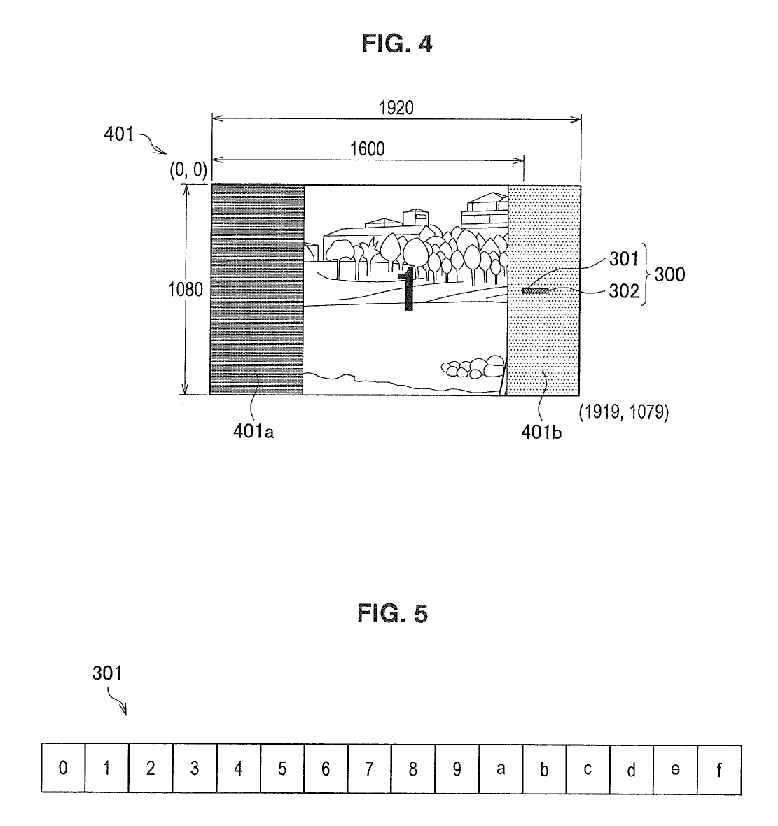

The image processing unit 12 superimposes (adds) addition control information 300 on a predetermined position of each of the output images 401 to 412. The addition control information 300 will be described later. The image processing unit 12 outputs the output images 401 to 412 to the communication unit 13. The communication unit 13 outputs each of the divided images 401a to 412a at each interval of at least 2V. The xy coordinates are set for each pixel constituting the output image (see FIG. 4). The coordinates of a pixel in the upper left end are (0, 0), and the coordinates of a pixel in the lower right end are (1919, 1079). The xy coordinates that are set in the output images are hereinafter referred to as output image coordinates.

(3-3. Superimposed Position and Configuration of Addition Control Information)

As described above, the image processing unit 12 superimposes the addition control information on each of the output images. Accordingly, the superimposed position and configuration of the addition control information 300 will now be described with reference to FIGS. 4 to 7.

FIG. 4 illustrates an example where the addition control information 300 is superimposed on a divided image 401a. As illustrated in FIG. 4, the image processing unit 12 superimposes the addition control information 300 on the position of output image coordinates (1600, 540). Specifically, the image processing unit 12 superimposes the leading pixel (leftmost pixel) of the addition control information 300 on the output image coordinates (1600, 540).

The reason why the addition control information 300 is superimposed on this position is described below. When the image processing device 10 is connected to the video equipment 20 through other device such as an amplifier, in some cases, the other device may superimpose any additional information (e.g., OSD output such as banner) on an output image. The other device superimposes additional information on the corner of the output image in many cases. Thus, when additional information is superimposed on the addition control information 300, the addition control information 300 will be overwritten by additional information. In addition, when the output image includes the divided images 401a to 412a, the addition control information 300 is necessary to be superimposed on the position at which the addition control information is not overlapped with the divided images 401a to 412a. Thus, the image processing unit 12 superimposes the addition control information 300 on the position of the output image coordinates (1600, 540). The addition control information 300 may be superimposed on any other positions as long as the above condition is satisfied.

The addition control information 300 is configured to include first addition control information 301 and second addition control information 302. The first addition control information 301 is information that is composed of 16 pixels, and the second addition control information 302 is information that is composed of 48 pixels. Each of the pixels constituting the addition control information 300 represents information in white or black. White indicates “1”, and black indicates “0”. In other words, the addition control information 300 represents information in a luminance value only. White is the color in which a luminance value ranges, for example, from 235 to 254, and black is the color in which a luminance value ranges from 1 to 16. The video equipment 20 recognizes information indicated by the addition control information 300 by converting (decoding) the color of each pixel into 0 or 1 using a predetermined threshold value.

The reason why the addition control information 300 is represented as information of a luminance value only is described below. If the addition control information 300 is represented as color information (e.g., chromaticity) other than a luminance value, it's color format may be converted into another, and thereby information content may be changed. For example, when the output image is generated using RGB color format and the color format of the output image is converted into YCbCr422 by the video equipment 20, the content of the addition control information 300 will be changed. However, the luminance value is unchanged even when the color format is converted. Thus, in the present exemplary embodiment, the addition control information 300 is represented as a luminance value only.

A more detailed configuration of the first addition control information 301 is illustrated in FIG. 5. The first addition control information 301 is composed of the 0th to f-th pixels. Further, in the description of the first addition control information 301 and second addition control information 302, information indicated by each pixel is represented as information after decoding, that is, “0” or “1”, and each pixel has a luminance value corresponding to “0” or “1”.

The 0th to 1st pixels indicate bit length of the first addition control information 301. In the present exemplary embodiment, the first addition control information 301 has a 2-byte (16 bits) length, thus the 0th pixel indicates “1” and the 1st pixel indicates “0”. In other words, in these pixels, “10” indicates “2 (decimal number)”. In addition, the bit length of the first addition control information 301 is not limited to the above example. For example, the first addition control information 301 may have a bit length of 3 bytes. In this case, both of the 0th pixel and the 1st pixel may indicate “1”.

The 2nd pixel is a flag indicating whether the output image is a blank image. As described later, the image processing unit 12 also generates a blank image as the output image. The blank image is not available to be displayed by the video equipment 20. If the 2nd pixel is “1”, the output image is a blank image. If the 2nd pixel is “0”, the output image is an image other than the blank image (e.g., divided images 401a to 412a described above).

The 3rd pixel is a flag indicating whether the output image is a reduced image. If the 3rd pixel is “1”, the output image is a reduced image. If the 3rd pixel is “0”, the output image is an image other than the reduced image (e.g., divided images 401a to 412a described above).

The 4th pixel is a flag indicating whether the input image 100a (i.e., divided images 401a to 412a) is a three-dimensional (3D) image (specifically, any of a right-eye image or left-eye image). If the 4th pixel is “1”, the input image 100a is a 3D image. If the 4th pixel is “0”, the input image 100a is a 2D image.

The 5th pixel is a flag indicating whether the input image 100a is a right-eye image or a left-eye image. If the 5th pixel is “1”, then the input image 100a is a left-eye image. If the 5th pixel is “0”, then the input image 100a is a right-eye image. When the input image 100a is a 3D image, any one of a right-eye image or a left-eye image may be outputted to the video equipment 20 previously than the other. For example, a left-eye image is first transmitted to the video equipment 20 and then a right-eye image is transmitted to the video equipment 20.

In addition, when the input image 100a is a 2D image, the 5th pixel may be any one of “1” or “0”, in this example, the 5th pixel is “1”. Thus, when the video equipment 20 is compatible with only 2D, the 4th pixel and the 5th pixel are typically “01”.

The 6th to 7th pixels constitutes an image identification index. In other words, the 6th and 7th pixels are information used to identify the input image 100a which is currently being transmitted to the video equipment 20. With the 6th to 7th pixels, four states of information, i.e., “00”, “01”, “10”, and “11” are represented. Whenever the input image 100a is changed into another, numerical values indicated by the 6th to 7th pixels are incremented by one. “11” is incremented to “00”. In other words, the image identification index may be a loop index.

The 8th to 9th pixels represent the signal frequency at which the divided images 401a to 412a are outputted. If the 8th and 9th pixels are “00”, it is indicated that the divided images 401a to 412a are outputted at a frequency of 59.94 Hz or 50 Hz. In this case, the number of repetitions of each divided image is two. If the 8th and 9th pixels are “01”, it is indicated that the divided images 401a to 412a are outputted at a frequency of 24 Hz. In this case, each divided image is written twice at a frequency of 48 Hz by a frequency conversion process in a pre-processing unit 22, and thus the number of repetitions is one. In addition, the 8th and 9th pixels may represent the number of repetitions of the divided images 401a to 412a. If the 8th and 9th pixels are “00”, the number of repetitions is two. If the 8th and 9th pixels are “01”, the number of repetitions is three. If the 8th and 9th pixels are “10”, the number of repetitions is four. If the 8th and 9th pixels are “11”, the number of repetitions is five. In addition, the image processing device may set the content (bit assignment) of the 8th to 9th pixels to any one of above-mentioned cases according to the input image format.

For example, if an output signal frequency of the divided images is 59.94 Hz, the communication unit 13 outputs each of the divided images 401a to 412a at each interval of 2V. The video equipment 20 captures the divided image 401a once every 2V. Similarly, for example, if an output signal frequency of the divided images is 24 Hz, the communication unit 13 outputs each of the divided images 401a to 412a to the video equipment 20 at each interval of 1V. The video equipment 20 writes the divided images 401a to 412a twice in the pre-processing unit 22, and thus video equipment 20 captures the divided image once every 2V. How to set the number of repetitions may be limited, for example, by the hardware constraint of the video equipment 20. In the following descriptions, the present exemplary embodiment will be described as an example when the output signal frequency of the divided images is 59.94 Hz and the number of repetitions is two.

The a-th to b-th pixels are not used in the present exemplary embodiment and both of them are “0”. These pixels may be set to represent any information.

The c-th to f-th pixels represent that the output image is what number of divided images. In other words, the c-th to f-th pixels may have numerical values ranging from “0000” to “1011”. “0000” indicates the first divided image, i.e., a divided image 401a, and “1011” indicates the 12th divided image, i.e., a divided image 412a.

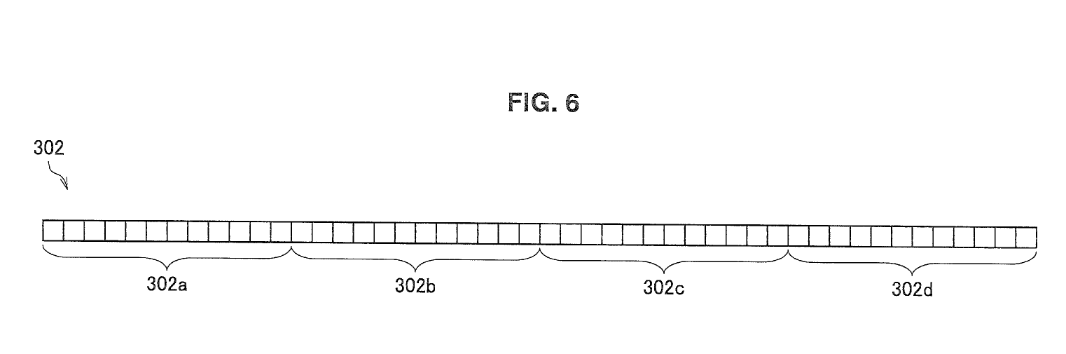

A more detailed configuration of the second addition control information 302 is illustrated in FIG. 6. The second addition control information 302 is composed of the first to fourth pixel rows 302a to 302d. The first pixel row 302a is configured to include 12 pixels and indicates a start position in horizontal direction (x direction) of the input image 100a. The start position in horizontal direction is the x-coordinate of a pixel A shown in FIG. 7 (a pixel constituting the upper left corner of the input image 100a). The first pixel row 302a may have values in the range of “000000000000”=“0 (decimal number)” to “111011111111”=“3839 (decimal number)”.

The second pixel row 302b is configured to include 12 pixels and indicates a start position in vertical direction (y direction) of the input image 100a. The start position of vertical direction indicates the y-coordinate of a pixel A shown in FIG. 7. The second pixel row 302b may have values in the range of “000000000000”=“0 (decimal number)” to “100001101111”=“2159 (decimal number)”.

The third pixel row 302c is configured to include 12 pixels and indicates a size in horizontal direction (x direction) of the input image 100a. The size in horizontal direction indicates the length of an arrow C shown in FIG. 7. The third pixel row 302c may have values in the range of “000000000001”=“1 (decimal number)” to “111100000000”=“3840 (decimal number)”.

The fourth pixel row 302d is configured to include 12 pixels and indicates a size in vertical direction (y direction) of the input image 100a. The size in vertical direction indicates the length of an arrow B shown in FIG. 7. The fourth pixel row 302d may have values in the range of “000000000001”=“1 (decimal number)” to “100001110000”=“2160 (decimal number)”.

Thus, output images generated from the same input image 100a have all the same second addition control information 302. In addition, as will be described later, if an output image is a blank image, the output image is not displayed and thus the second addition control information 302 is not necessary. Accordingly, if an output image is a blank image, the second addition control information 302 may be deleted. In this case, as will be described later, each of pixels constituting the second addition control information 302 preferably has the same color as the background color.

The video equipment 20 can recognize the input image 100a and marginal image 100b in the 4K original image 100 based on the second addition control information 302. The video equipment 20 may perform a seizing prevention process or the like for the marginal image 100b. For example, if an image output unit 24 is a liquid crystal display, the video equipment 20 may perform a backlight control that prevents a blur from occurring in the marginal image 100b. In addition, if the image output unit 24 is an organic EL display, the video equipment 20 may perform a control for reducing the luminance difference between the marginal image 100b and the input image 100a. Accordingly, seizing of the organic EL display is suppressed.

Furthermore, if each pixel row of the second addition control information 302 indicates a value outside the range described above, the video equipment 20 determines that the second addition control information 302 is in error. In this case, the video equipment 20 may determine that the entire 4K original image 100 is composed of the input image 100a.

(3-4. Authentication Process (Authentication Test))

An authentication process will now be described. As described above, the image processing device 10 outputs each of the divided images 401a to 412a while switching into another at each interval of 2V. Thus, if the video equipment 20 is incompatible with combining of the divided images 401a to 412a, these divided images 401a to 412a may be displayed without switching. Accordingly, if the video equipment is incompatible with combining of the divided images 401a to 412a, it is necessary for the divided images 401a to 412a not to be outputted.

Therefore, as will be described later, the image processing unit 12 previously acquires EDID information from the video equipment 20. The image processing unit 12 determines whether the video equipment 20 is compatible with combining of the divided images 401a to 412a (hereinafter, simply referred to as “compatible with 4K combining”) based on the EDID information. However, when the image processing device 10 is connected to the video equipment 20 through other devices such as amplifier, in some cases, the image processing unit 12 may not acquire EDID information from the video equipment 20 depending on the type of the other device. In addition, combining-capable information of the EIDI information which indicates whether the video equipment 20 is compatible with the 4K combining may be unavailable for some reasons. In these cases, the image processing unit 12 may not determine whether the video equipment 20 is compatible with the 4K combining

Thus, in these cases, the image processing unit 12, before outputting the divided images 401a to 412a, performs the following authentication process. As a result, the image processing unit 12 checks whether the video equipment 20 is compatible with the 4K combining

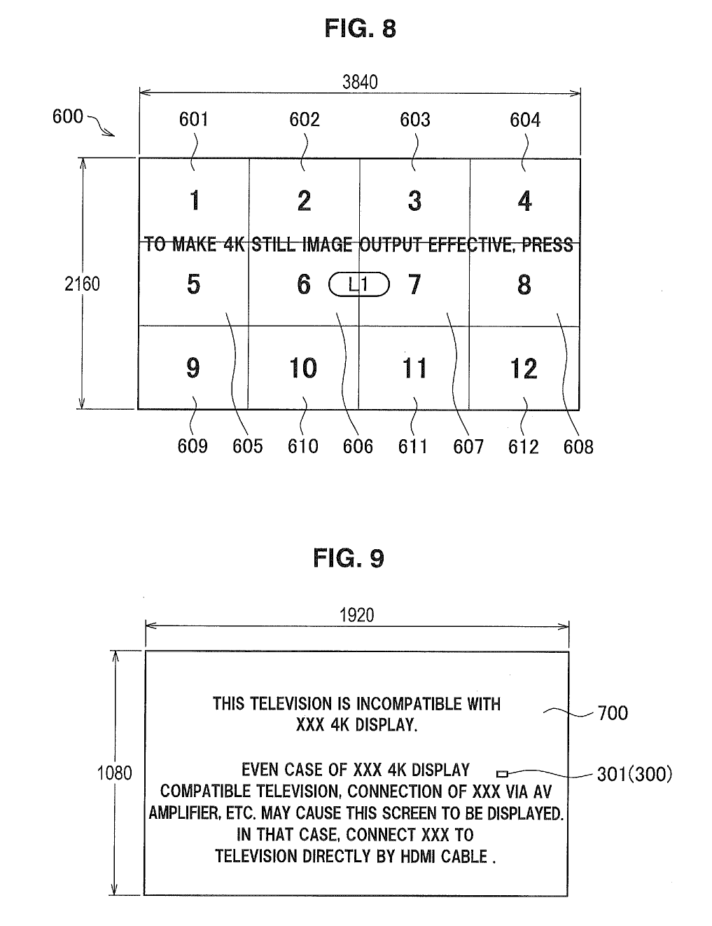

Specifically, as shown in FIG. 8, the image processing unit 12 generates a description image 600 in which a trigger operation necessary to initiate the generation of the divided images 401a to 412a is described. The description image 600 has 4K resolution. In addition, the trigger operation may be a “press L1 button” operation. Further, the image processing unit 12 preferably changes the trigger operation randomly each time the description image 600 is generated so that a user other than the user who visually recognizes the description image 600 is prevented from perceiving the trigger operation. Even if the user is aware of some trigger operations through the Internet or the like, it may not possible to initiate outputting the divided images 401a to 412a unless the user actually performs the trigger operation described in the description image 600.

The image processing unit 12 divides the description image 600 into 12 divided description images 601 to 612. In addition, in FIG. 8, the description image 600 is simply divided into 12 images, but, actually, the divided description images 601 to 612 which are partially overlapped with each other are generated as a similar manner to the divided images 401a to 412a described above.

The image processing unit 12 generates an output image including the divided description images 601 to 612 by performing a similar process to the case of generating the output images 401 to 412 as described above. The image processing unit 12 superimposes the addition control information 300 on the output image. In this case, the image processing unit 12 generates the addition control information 300 by regarding the description image 600 as a normal input image 100a (it is not be a blank image 700 or reduced image 200). The image processing unit 12 outputs the output image to the communication unit 13. The communication unit 13 outputs the output image to the video equipment 20 at each interval of at least 2V. In addition, the communication unit 13 is necessary to cause the description image 600 to be displayed on the video equipment 20 for a predetermined time period (e.g., approximately two seconds), thus the communication unit 13 outputs the divided description images 601 to 612 in which the loop is carried out two times or more. In the first loop, the divided description images 601 to 612 are outputted at each interval of 2V.

The image processing unit 12 unifies background colors of the description image 600. The reason is as follows. If background colors of the description image 600 are not unified, background color of each of the divided description images 601 to 612 will be not unified. On the other hand, when the video equipment 20 is incompatible with combining of the divided images 401a to 412a, the video equipment 20 may not perform combining of the divided description images 601 to 612. Thus, the video equipment 20 displays these divided description images 601 to 612 sequentially in a short period of time. Accordingly, if background colors of the description image 600 are not unified, images with different colors may be displayed in a short period of time. In this case, there is a possibility that the user suffers from fatigue caused by visually recognizing the image. Thus, in the present exemplary embodiment, background colors of the description image 600 are unified. From this point of view, background color is preferably selected to be a color that allows user's fatigue due to visual recognition to be reduced as much as possible, for example, gray color. In addition, background color may be varied to some extent in a range in which users not feel the burden of visual recognition.

Subsequently, the image processing unit 12 generates a blank image (unavailable image) 700 shown in FIG. 9. In the blank image 700, information indicating that the video equipment 20 is incompatible with combining of the divided images 401a to 412a is described. In the illustrated example, textual information “this television is incompatible with xxx 4K display” is described. In this information, “xxx” may be a product name of the video equipment 20. In addition, the image processing unit 12 reserves a memory region for the blank image 700.

Moreover, as described above, the image processing unit 12, in some cases, may not read EDID information due to some other devices between the image processing device 10 and the video equipment 20. In the blank image 700, Information indicating that there is a possibility that 4K original image is not displayed due to other devices and information indicating that it is necessary to demand the direct connection of the image processing device 10 and the video equipment 20 may be described.

The image processing unit 12 generates an output image including the blank image 700 and superimposes the addition control information 300 on the output image. The addition control information 300 may be substantially composed of only the first addition control information 301. Specifically, pixels having the same color as the background color are disposed in a position on which the second addition control information 302 is superimposed. The reason for this is that the addition control information 300 is to be inconspicuous.

The image processing unit 12 outputs an output image to the communication unit 13. The communication unit 13 outputs the output image, that is, the blank image 700 to the video equipment 20 for a predetermined time of period (e.g., approximately 15 seconds). The video equipment 20 performs the following processes according to the authentication process.

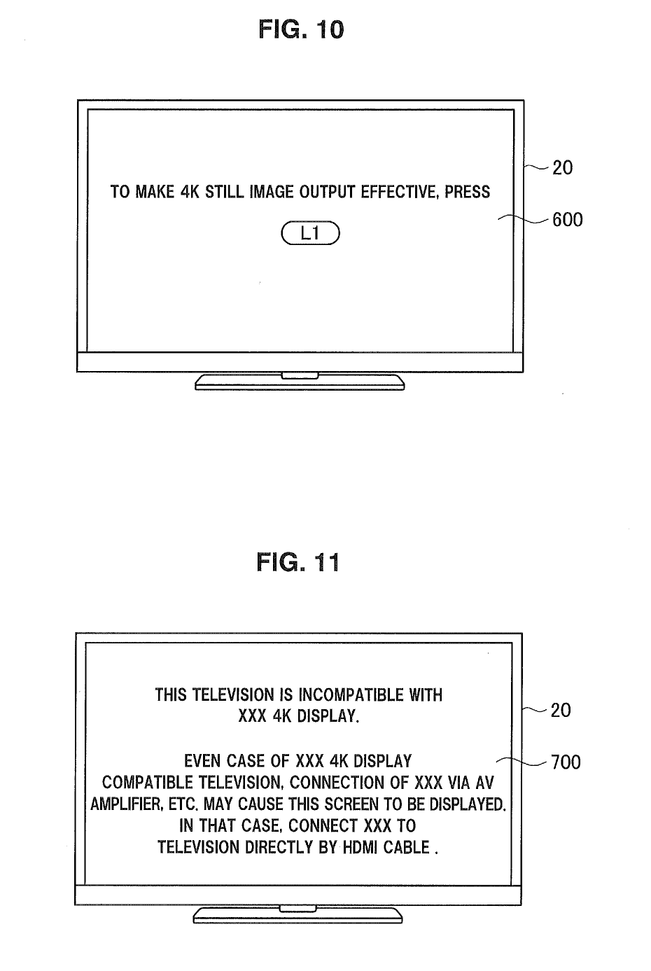

If the video equipment 20 is compatible with 4K combining, the video equipment 20 combines divided description images 601a to 612a and restores a description image 600. Thus, as shown in FIG. 10, the video equipment 20 can display the description image 600. Accordingly, the user can recognize a trigger operation, and thus the user performs the trigger operation. When the trigger operation is performed, the image processing unit 12 initiates the generation of divided images 401a to 412a. In addition, even if the video equipment 20 receives an output image including the blank image 700 later, the video equipment 20 can recognize that the output image is the blank image 700 based on the addition control information 300. Thus, the video equipment 20 does not display the blank image 700.

On the other hand, if the video equipment 20 is incompatible with combining of the divided images 401a to 412a, the video equipment 20 displays the divided description images 601 to 612 sequentially. The video equipment 20 then displays the blank image 700, as shown in FIG. 11. The video equipment 20 may not read the addition control information 300, because the video equipment 20 may not determine whether the output image is the blank image. That is, in the present exemplary embodiment, if the video equipment 20 is compatible with 4K combining, it does not display the blank image 700, but if the video equipment 20 is incompatible with 4K combining, it displays the blank image 700. In the present exemplary embodiment, by using it differently, various information (e.g., information indicating that the video equipment 20 is incompatible with combining of the divided images 401a to 412a) is incorporated into the blank image 700.

With this, the user can easily determine whether the video equipment 20 is compatible with 4K combining. In addition, in the blank image 700, information indicating that there is a possibility that 4K original image is not displayed due to the other devices is described, and thus unnecessary calls of the call center is reduced.

The image processing unit 12 may generate the blank image 700 even in the cases other than the authentication process. For example, the image processing unit 12 generates the blank image 700 during a predetermined waiting time after changing SPD Infoframe. In this case, the above-described information may not be described in the blank image 700.

(3-5. Processing Relevant to SPD Infoframe)

The image processing unit 12 generates SPD (Source Product Description) Infoframe and outputs the generated SPD Infoframe to the communication unit 13. The communication unit 13 outputs the SPD Infoframe to the video equipment 20. The SPD Infoframe is information in which device name of the image processing device 10 or the like is described. The image processing unit 12 notifies that the output of divided images 401a to 412a is started to the video equipment 20 using the SPD Infoframe. In other words, when the output of divided images 401a to 412a is started, the image processing unit 12 instructs the communication unit 13 to temporarily stop outputting a TMDS signal. In response to this instruction, the communication unit 13 stops outputting a TMDS signal temporarily.

The image processing unit 12 then incorporates output start information which indicates that the output of divided images 401a to 412a is started in the SPD Infoframe. On the other hand, when the output of divided images 401a to 412a is ended, the image processing unit 12 deletes the output start information from the SPD Infoframe.

The image processing unit 12 then outputs the SPD Infoframe to the communication unit 13. The communication unit 13 outputs the SPD Infoframe and resumes transmission of the TMDS signal. On the other hand, if the transmission of the TMDS signal is interrupted, the video equipment 20 reads SPD Infoframe that is received after the transmission of the TMDS is resumed. Thus, the video equipment 20 can easily determine whether the output of divided images 401a to 412a is started. In addition, if the image processing device 10 is connected to the video equipment 20 through other devices, in some cases, the video equipment 20 may not receive SPD Infoframe. From this viewpoint, the above-described authentication process is important.

The image processing unit 12 performs processes such as a control of the entire image processing device, an execution of a photographic reproduction application, and a display setting of the video equipment 20 in addition to the above-described processes. Further, the image processing unit 12 can also perform the generation of an image with 2K resolution.

The communication unit 13, when receiving an output image, reads the addition control information 300, and outputs the output image to the video equipment 20 based on the addition control information 300.

<4. Configuration of Video Equipment>

Referring to FIG. 1, a configuration of the video equipment 20 will be described. The video equipment 20 is configured to include a communication unit 21, a pre-processing unit 22, an image processing unit 23, and an image output unit 24. In addition, the video equipment 20 may be a television receiver, and includes hardware components such as CPU, ROM, RAM, hard disk, communication device, and display panel. The ROM stores a program used to allow the video equipment 20 to implement the communication unit 21, the pre-processing unit 22, the image processing unit 23, and the image output unit 24. The CPU reads the program stored in the ROM and executes it. Thus, the communication unit 21, the pre-processing unit 22, the image processing unit 23, and the image output unit 24 are implemented by these hardware components.

The communication unit 21 is connected to the communication unit 13 of the image processing device 10 through an HDMI cable 30, and the communication unit 21 transmits and receives a TMDS signal to and from the communication unit 13. The communication unit 21 outputs information (e.g., output image, etc.) received from the communication unit 13 to the pre-processing unit 22. In addition, the communication unit 21 outputs information provided from the pre-processing unit 22 or the like to the image processing device 10.

The pre-processing unit 22 controls internal components of the video equipment 20 and performs the following processes. For example, if a TMDS signal is interrupted, the pre-processing unit 22 reads SPD Infoframe after the TMDS signal is resumed. If the SPD Infoframe includes output start information, the pre-processing unit 22 performs a signal path switching control or the like. In addition, the pre-processing unit 22 decodes the addition control information 300 that is included in the output image (converts a luminance value into “0” or “1”). The pre-processing unit 22 determines the type of the output image based on the addition control information 300. If the output image includes the reduced image 200, the pre-processing unit 22 outputs the output image to the image processing unit 23.

On the other hand, if the output image includes the divided image 401a or the divided description image 601a, the pre-processing unit 22 attaches a LR flag to the output image and outputs it to the image processing unit 23. In addition, if the output image is the blank image 700, the pre-processing unit 22 discards the output image.

If the output image includes the reduced image 200, the image processing unit 23 detects a facial image from the reduced image 200. The image processing unit 23 then records a color which is included in the facial image in a memory (a super-resolution process suppression color table). In addition, if the output image includes a LR flag, the image processing unit 23 restores a 4K original image 100 (or description image 600) by capturing the divided images 401a to 412a (or divided description images 601 to 612). That is, the image processing unit 23 captures the divided images 401a to 412a (or divided description images 601 to 612) by regarding the LR flag as a trigger.

The image processing unit 23 has at least one buffer to restore the 4K original image 100 (or description image 600). Each buffer has a memory region for 4K resolution. The xy coordinates are set in the buffer. The coordinates of a pixel in the upper left end are (0, 0), and the coordinates of a pixel in the lower right end are (3839, 2159). The xy coordinates that are set in the buffer are hereinafter referred to as restored image coordinates.

If the video equipment 20 is compatible with 3D, the image processing unit 23 has at least two buffers. The two buffers correspond to a set of left-eye image and right-eye image. The buffers for capturing the divided images 401a to 412a are switched between each other by the image processing unit 23 every time the left-eye image and right-eye image of the input image 100a are switched between each other.

In other words, when the image processing device 10 outputs the divided images 401a to 412a at each interval of 2V, the image processing unit 12 initiates the V Sync count after receiving the divided image 401a, and captures divided images (specifically, output image containing the divided image) at each interval of 1V, i.e., an odd number of times. In this case, the capturing is ended at 23th V. on the other hand, the image processing unit 12 extracts a captured image with a predetermined capture size from a capture start position among the captured output images and restores the 4K original image 100 (i.e., generates the 4K restoration image 500) by attaching the extracted captured image to a predetermined restoration position of the buffer.

An exemplary process of restoring the 4K original image 100 will now be described with reference to FIG. 12. The image processing unit 23 reserves a memory region for 2K resolution in advance and captures the output image 401 having the divided image 401a into the memory region.

The image processing unit 23 then extracts the captured image 501 with a predetermined capture size from a predetermined capture start position of the output image 401 and attaches the extracted captured image 501 to a predetermined restoration position of the buffer.

Similarly, the image processing unit 23 captures the output image 402 to 412 into the memory region sequentially, and extracts the captured images 502 to 512 with a predetermined size from a predetermined capture start position of each of the output image 402 to 412. The image processing unit 23 then attaches each of the captured images 502 to 512 to a predetermined restoration position. Thus, the image processing unit 23 restores a 4K original image 100. That is, the image processing unit 23 generates a 4K restoration image 500.

The capture start position is the output image coordinates of pixels constituting the upper left end of the captured images 501 to 512. The capture size is the size of the captured images 501 to 512, and its unit is a pixel (picture element). The restoration position is the restoration image coordinates of pixels constituting the upper left end of the captured images 501 to 512. The capture start position, capture size, and restoration position of each of the captured images 501 to 512 are listed in the following Table 2.

TABLE 2

| Captured | Capture Start | | Restoration |
|---|---|---|---|
| Image | Position | Capture Size | Position |
| 501 | 0, 0 | 1024 × 720 | 0, 0 |
| 502 | 256, 0 | 1024 × 720 | 1024, 0 |
| 503 | 256, 0 | 1024 × 720 | 2048, 0 |
| 504 | 512, 0 | 768 × 720 | 3072, 0 |
| 505 | 0, 180 | 1024 × 720 | 0, 720 |
| 506 | 256, 180 | 1024 × 720 | 1024, 720 |
| 507 | 256, 180 | 1024 × 720 | 2048, 720 |
| 508 | 512, 180 | 768 × 720 | 3072, 720 |
| 509 | 0, 360 | 1024 × 720 | 0, 1440 |
| 510 | 256, 360 | 1024 × 720 | 1024, 1440 |
| 511 | 256, 360 | 1024 × 720 | 2048, 1440 |
| 512 | 512, 360 | 768 × 720 | 3072, 1440 |

The image processing unit 23 performs a super resolution process with respect to the 4K resolution image 500. The image processing unit 23 prevents the super resolution process from being performed for a color which is recorded in the super resolution process suppression color table. As a result, the image processing unit 23 prevents the expression of skin from being rough. In addition, the super resolution process is schematically the complementary process of pixels. The image processing unit 23 outputs the 4K restoration image 500 obtained after performing the super resolution process to the image output unit 24. The image output unit 24 displays the 4K restoration image 500.

<5. Overview of Process performed by Image Processing System>

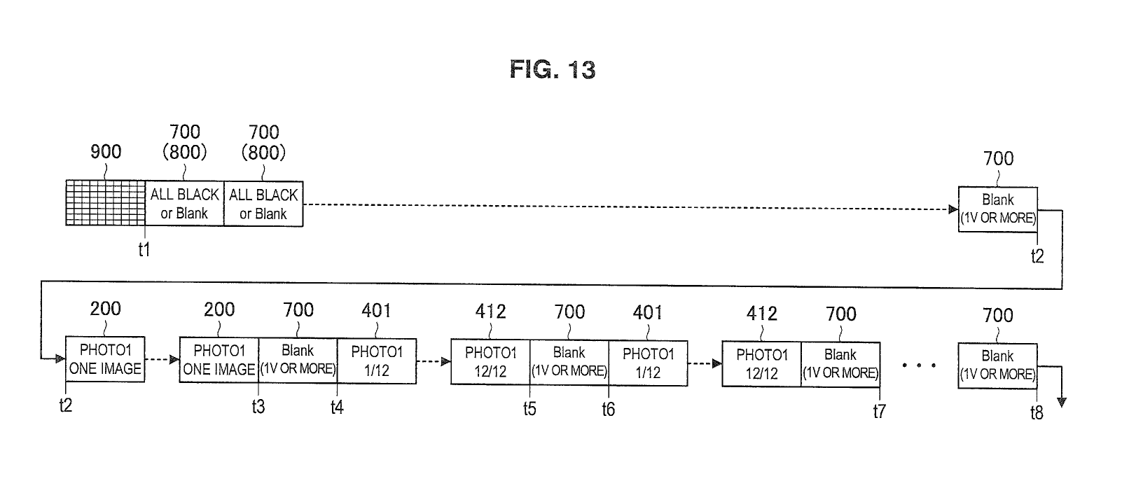

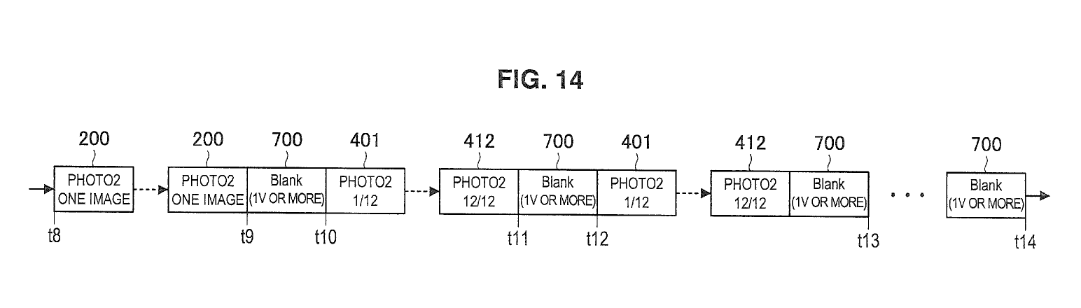

An overview of the process performed by the image processing system will be described with reference to timing charts shown in FIGS. 13 to 15. In this example, the image processing device 10 recognizes that the video equipment 20 is compatible with 4K combining based on the EDID information. In addition, the addition control information 300 is included in an image which is generated by the image processing unit 12.

The image processing unit 12 executes a photographic reproduction application. Specifically, the image processing unit 12 generates a thumbnail image 900 in which photographic images are listed, and outputs the generated thumbnail image 900 to the communication unit 13. In addition, the thumbnail image 900 has 2K resolution. The communication unit 13 outputs the thumbnail image 900 to the video equipment 20. The image output unit 24 of the video equipment 20 displays the thumbnail image 900.

When the user selects any one of the photographic images, the image processing unit 12 instructs the communication unit 13 to temporarily stop transmitting a TMDS signal for the time interval from t1 to t2. The communication unit 13 stops transmitting the TMDS signal that has been outputted until then. In response to this, the video equipment 20 performs an image mute process (a process of stopping displaying an image on the image output unit 24). In addition, in the image mute process, an all black image 800 described later may be displayed.

The image processing unit 12 incorporates the output start information into SPD Infoframe and outputs it to the communication unit 13. Thereafter, the communication unit 13 resumes the output of a TMDS signal and simultaneously outputs the SPD Infoframe. Then, the image processing unit 12 generates a blank image 700 or all black image 800 (both have 2K resolution) and outputs it to the communication unit 13. The all black image 800 is composed of pixels whose color is all black. The addition control information 300 that is added to the all black image 800 may be similar to that of the blank image 700. The communication unit 13 outputs the blank image 700 or the all black image 800 to the video equipment 20 for the interval of 60V or more. In addition, the communication unit 13 outputs the blank image 700 for the interval of 1V or more before outputting an output image including the reduced image 200.

On the other hand, the video equipment 20 prepares for generating the 4K restoration image 500. Specifically, the pre-processing unit 22 performs the image mute process (a process of stopping displaying an image on the image output unit 24). On the other hand, the pre-processing unit 22 reads SPD Infoframe after the TMDS signal is resumed. The pre-processing unit 22 then reads the output start information from the SPD Infoframe and performs a signal path switching control or the like (a switching control to be compatible with 4K output). In addition, the pre-processing unit 22 discards the blank image 700 and the all black image 800. The pre-processing unit 22 may cause the image output unit 24 to display the all black image 800.

Over the time interval from t1 to t2, the image processing unit 12 sets a first photographic image (photo 1) selected by the user as an input image 100a, and generates a reduced image 200 by the above-described process. The image processing unit 12 then superimposes addition control information 300 on the reduced image 200. The image processing unit 12 then sets the reduced image 200 as an output image and outputs it to the communication unit 13. The communication unit 13 outputs the output image for the interval of 12V or more.

The communication unit 21 of the video equipment 20 outputs the output image to the pre-processing unit 22. The pre-processing unit 22 recognizes that the output image is the reduced image 200 based on the addition control information 300 in the output image, and outputs the reduced image 200 to the image processing unit 23. The image processing unit 23 detects a facial image from the reduced image 200 and records a color included in the facial image in the super resolution process suppression color table.

Over the time interval from t3 to t4, the image processing unit 12 generates a blank image 700 and outputs the blank image 700 as an output image to the communication unit 13. The communication unit 13 outputs the output image for the interval of 1V or more. The communication unit 21 of the video equipment 20 outputs the output image to the pre-processing unit 22. The pre-processing unit 22 recognizes that the output image is the blank image 700 based on the addition control information, and then discards the blank image 700.

Over the time interval from t4 to t5, the image processing unit 12 generates divided images 401a to 412a by performing the above-described process and also generates output images 401 to 412 including the divided images 401a to 412a. The image processing unit 12 then outputs the output images 401 to 412 to the communication unit 13. The communication unit 13 outputs the output images 401 to 412 to the video equipment 20 (a first loop). This is performed at each interval of 2V (note that this value will vary according to information of eight to ninth pixels in the first addition control information 301). On the other hand, the communication unit 13 of the video equipment 20 outputs the output image 401 to 412 to the pre-processing unit 22. The pre-processing unit 22 and the image processing unit 23 generates a 4K restoration image 500 by performing the above-described process, and outputs it to the image output unit 24. At this time, the image output unit 24 does not display an image.

Over the time interval from t5 to t6, the image output unit 24 starts displaying the 4K restoration image 500 (a first photographic image) (displaying may be started by fade in, or may not be fade in). On the other hand, image processing unit 12 generates a blank image 700 and outputs the blank image 700 to the communication unit 13 as an output image. The communication unit 13 outputs the output image for the interval of 1V or more. The video equipment 20 discards the blank image 700.

Over the time interval from t6 to t7, the image processing system performs a similar process to that of the time interval from t4 to t6. Specifically, the image processing device 10 outputs the output images 401 to 412 and blank image 700 obtained in the second loop. Thereafter, the image processing device 10 repeats the output of the output image 401 to 412 and blank image 700 (so called, a loop output) until the user selects other photographic image. In addition, the reason why the image processing device 10 repeats the loop output is as follows.

When the user switches an input to the video equipment 20 into another input (e.g., a digital terrestrial television broadcasting input) from the image processing device 10 while viewing a photographic image and then returns to the original input, the video equipment 20 will lost the photographic image. As a result, when the image processing device 10 stops the loop output after the video equipment 20 starts displaying the photographic image, the video equipment 20 becomes not be able to display the photographic image until the user selects other photographic image. Thus, the image processing device 10 repeats the loop output until the user selects other photographic image. This makes it possible for the video equipment 20 to receive the output images 401 to 412 after the input is returned to the original and restore the photographic image based on the output images 401 to 412.

On the contrary, when the video equipment 20 successfully generates a 4K restoration image 500, the video equipment 20 may not perform again capturing of the divided images 401a to 412a in a case where photographic image is switched, or until the input is returned to the original input after the input is switched as described above.

Subsequently, at time t8, when the user selects the second photographic image (photo 2), during the time interval from t8 to t9, the image processing system performs a process similar to that performed in the time interval from t2 to t3 for the photo 2. Then, in the time intervals from t9 to t10, from t10 to t11, from t11 to t12, from t12 to t13, and from t13 to t14, the image processing system performs processes similar to those performed in the time intervals from t3 to t4, from t4 to t5, from t5 to t6, from t6 to t7, and from t7 to t8, respectively. The image processing unit 23 of the video equipment 20 continues to display the photo 1 because an output image relevant to the photo 2 is not inputted at least until at time t8. The image processing unit 23 causes the photo 2 to be faded in from the time at which an output image relevant to the photo 2 is first inputted (a time at which a first image of photo 2, i.e., reduced image 200 is inputted, e.g., the time t8) to the time at which the photo 1 fades out and then restoration of the photo 2 is ended (a time at which a 4K restoration image 500 is successfully generated, e.g., the time t11). In this way, the image processing device 10 can immediately start decoding the photo 2 before the user selects the photo 2. In other words, the image processing device 10 starts decoding the photo 2 while the video equipment 20 displays the photo 1. If the decoding is completed when the user selects the photo 2, the image processing device 10 can immediately start a division transmission. When one image of the photo 2 is first inputted, the video equipment 20 fades out the photo 1. Thus, it looks to the user as if the fade out as a feedback with respect to a selection operation of a photographic image has been made. In other words, the user can recognize that a selection operation of photographic image is accepted by visually recognizing a fade out.

Thereafter, at time t14, when the user selects a third photographic image (photo 3), the image processing device 10 generates a reduced image 200 corresponding to the photo 3 and start outputting an output image including the reduced image 200.

Subsequently, at time t15, when the user performs a stop operation, the image processing unit 12 generates a blank image 700 and outputs it to the communication unit 12 as an output image. The communication unit 13 outputs the output image to the video equipment 20 for the interval of 1V or more. The video equipment 20 discards the blank image 700. The image processing unit 12 then generates an all black image 800 and outputs it to the communication unit 13. The communication unit 13 outputs the all black image 800 to the video equipment 20 in a predetermined time period (until the change of SPD Infoframe is completed in the image processing device 10).

On the other hand, the image processing unit 12 instructs the communication unit 13 to temporarily stop transmitting a TMDS signal. The communication unit 13 temporarily stops transmitting a TMDS signal. In response to this, the pre-processing unit 22 of the video equipment 20 performs an image mute process.

Subsequently, the image processing unit 12 generates SPD Infoframe that does not include output start information and outputs it to the communication unit 13. The communication unit 13 resumes the transmission of the TMDS signal and outputs SPD Infoframe to the video equipment 20. The pre-processing unit 22 of the video equipment 20 reads SPD Infoframe after the transmission of the TMDS signal is resumed. The pre-processing unit 22 checks that the output start information is not included in the SPD Infoframe and performs a signal path switching control (a switching control to be compatible with 2K output) or the like. Thereafter, at time t16 and the subsequent times, the image processing system performs a process similar to that performed before time t1. In addition, in the above-described example, the blank image 700 is inserted at the timing of switching of the photographic image. However, if the input image 100a is a 3D image, then the blank image 700 may not be inserted at the timing of switching of the photographic image (i.e., at the timing when a right-eye image and a left-eye image are switched between each other).

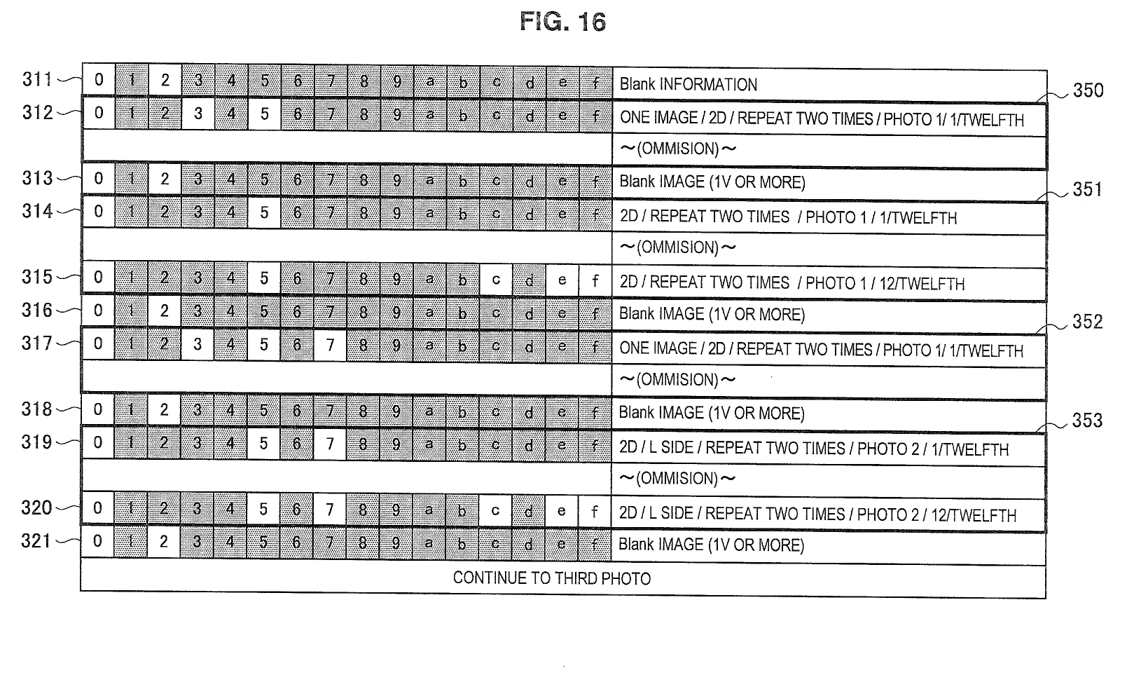

FIG. 16 shows the first addition control information 311 to 321 at each time described above. White pixels indicate “1”, and black pixels indicate “0”. In other words, the first addition control information 311 indicates the first addition control information 301 assigned to the output image (a blank image 700) over a time period from t1 to t2. In the first addition control information 311, the 0th pixel and the second pixel indicate “1”.

The first addition control information 312 and so on surrounded by a frame 350 indicates the first addition control information 301 assigned to the output image over a time period from t2 to t3. The first addition control information 313 indicates the first addition control information 301 assigned to the output image (a blank image 700) over a time period from t3 to t4.

The first addition control information 314, 315, and so on surrounded by a frame 351 indicate the first addition control information 301 corresponding to the output images 401 to 412 outputted over a time period from t4 to t5. Specifically, the first addition control information 314 corresponds to the output image 401, and the first addition control information 315 corresponds to the output image 412. The first addition control information 316 indicates the first addition control information 301 assigned to the blank image 700 outputted over a time period from t5 to t6.

The first addition control information 317 and so on surrounded by a frame 352 indicates the first addition control information 301 assigned to the output image over a time period from t8 to t9. The first addition control information 318 indicates the first addition control information 301 assigned to the output image (a blank image 700) over a time period from t9 to t10.

The first addition control information 319, 320, and so on surrounded by a frame 353 indicate the first addition control information 301 corresponding to the output images 401 to 412 outputted over a time period from t10 to t11. Specifically, the first addition control information 319 corresponds to the output image 401, and the first addition control information 320 corresponds to the output image 412. The first addition control information 321 indicates the first addition control information 301 assigned to the output image (a blank image 700) outputted over a time period from t11 to t12.

<6. Processing performed by Image Processing System>

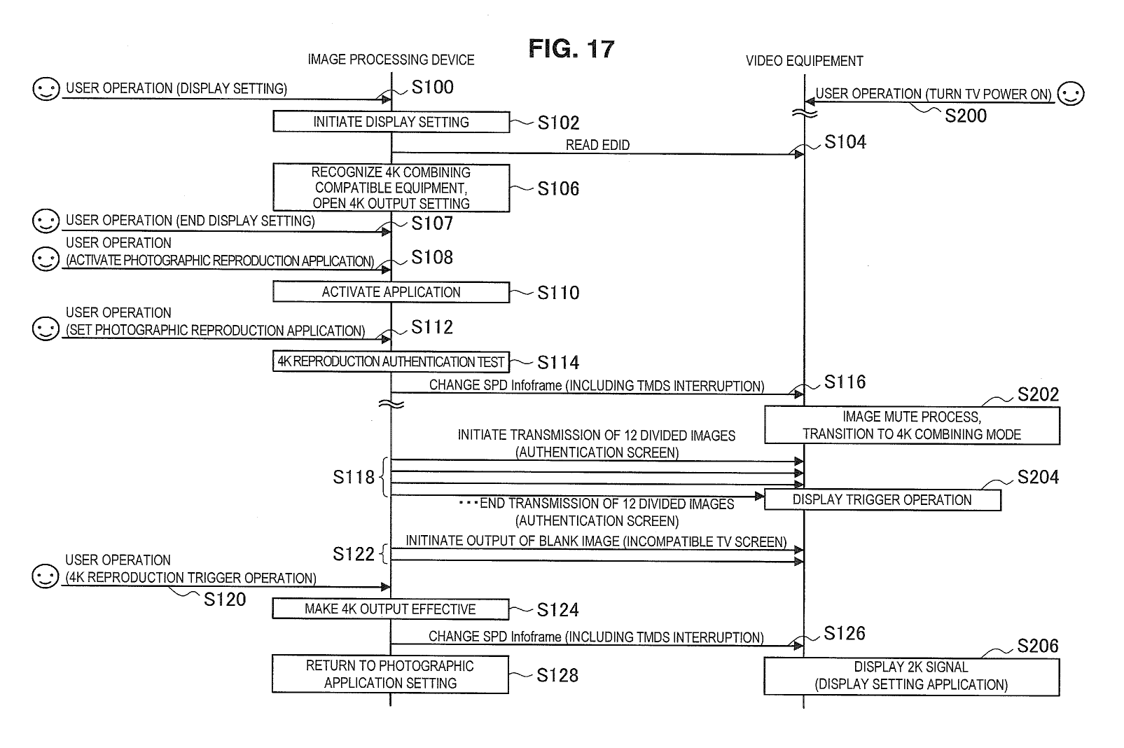

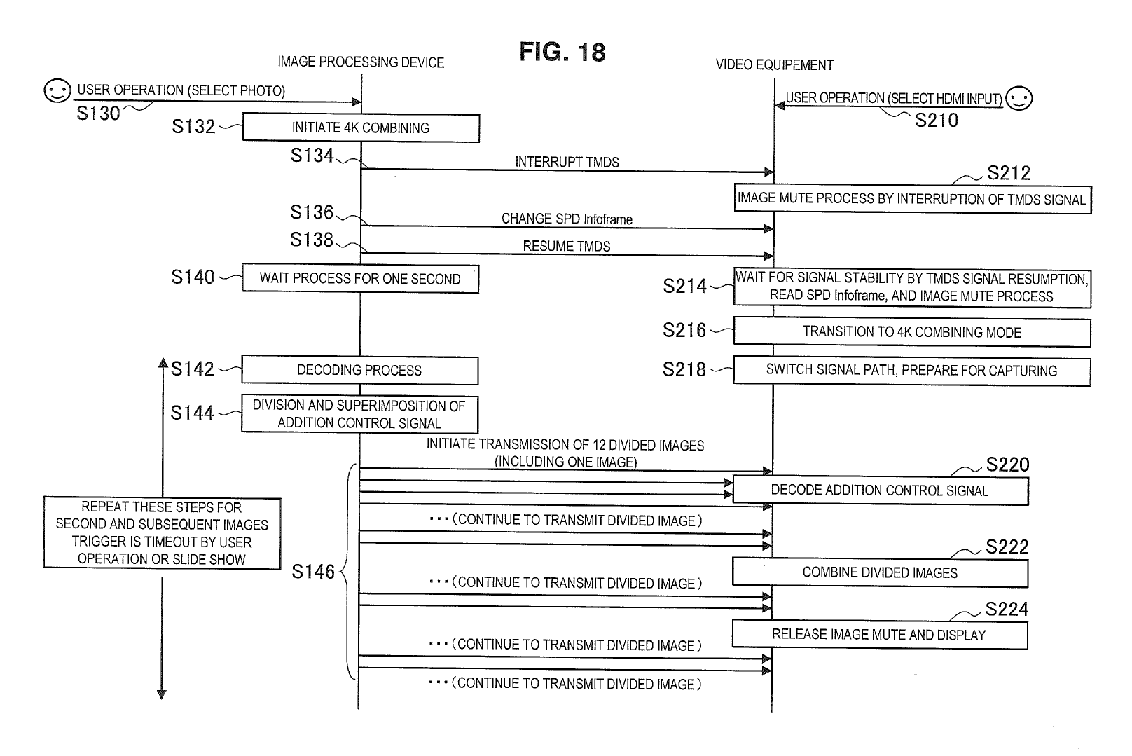

A process to be performed by the image processing system will be described in detail with reference to sequence diagrams shown in FIGS. 17 and 18. Referring to FIG. 17, a description will be made of changing a setting (switching between 4K output and 2K output).

In step S200, a user turns on the power of the video equipment 20. In step S100, the user performs an input operation for a display setting. In step S102, the image processing unit 12 of the image processing device 10 performs various display settings.

In step S104, the image processing unit 12 generates EDID request information for requesting EDID information and outputs the generated EDID request information to the communication unit 13. The communication unit 13 outputs the EDID request information to the video equipment 20. The communication unit 21 of the video equipment 20 outputs the EDID request information to the pre-processing unit 22. The pre-processing unit 22 generates EDID information and outputs it to the communication unit 21. When the video equipment 20 is compatible with 4K combining, the pre-processing unit 22 incorporates combining-capable information indicating that the video equipment 20 is compatible with 4K combining into the EDID information. The communication unit 21 outputs the EDID information to the image processing device 10. The communication unit 13 of the image processing device 10 outputs the EDID information to the image processing unit 12.

In step S106, the image processing unit 12 determines whether the video equipment 20 is compatible with 4K combining based on the EDID information. As the determination result, if it is determined that the video equipment 20 is compatible with 4K combining, then the image processing unit 12 opens a setting for 4K output (i.e., a setting necessary for generating divided images 401a to 412a is performed). In step S107, the user ends the display setting operation.

In step S108, the user performs an input operation for activating a photographic reproduction application. In step S110, the image processing unit 12 activates the photographic reproduction application. In step S112, the user performs various setting operations related to the photographic reproduction application.

In step S114, if a determination whether the video equipment 20 is compatible with 4K combining is unable to be made in step S106, the image processing unit 12 initiates the above-described authentication process (authentication test). Specifically, in step S116, the image processing unit 12 instructs the communication unit 13 to temporarily stop transmitting a TMDS signal. The communication unit 13 temporarily stops transmitting the TMDS signal. The image processing unit 12 then incorporates output start information into SPD Infoframe and outputs it to the communication unit 13. The communication unit 13 resumes the output of the TMDS signal and outputs the SPD Infoframe.

In step S202, the pre-processing unit 22 performs an image mute process. On the other hand, the pre-processing unit 22 reads SPD Infoframe after the TMDS signal is resumed. The pre-processing unit 22 then reads the output start information from the SPD Infoframe, and performs a signal path switching control (a switching control to be compatible with 4K output) or the like. This allows the video equipment 20 to be changed into 4K combining mode.

Subsequently, in step S118, the image processing unit 12 generates a description image 600 in which a trigger operation is described and generates an output image including divided description images 601 to 612. The image processing unit 12 then superimposes addition control information 300 on an output image. The image processing unit 12 outputs the output image to the communication unit 13. The communication unit 13 outputs the output image to the video equipment 20 at each interval of 2V.

In step S204, if it is compatible with 4K combining, the pre-processing unit 22 and the image processing unit 23 restore a description image 600 and cause the image output unit 24 to display it based on the divided description images 601 to 612. In addition, the description image 600 is restored in a similar manner to the generation of the 4K restoration image 500. Subsequently, in step S122, the image processing unit 12 generates an blank image 700 shown in FIG. 9. The image processing unit 12 then outputs the blank image 700 to the communication unit 13. The communication unit 13 outputs the blank image 700 to the video equipment 20. If the video equipment 20 is compatible with 4K combining, in step S120, the user performs a trigger operation according to the restored description image 600. If the video equipment 20 is incompatible with 4K combining, the divided description images 601 to 612 are displayed on the image output unit 24 and then the blank image 700 is displayed on the image output unit 24.

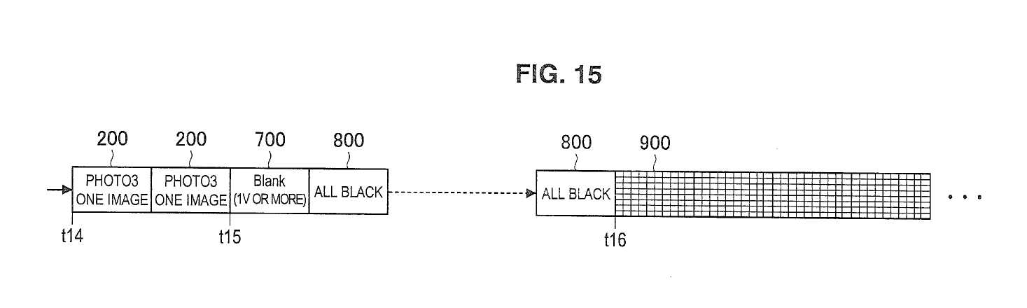

In step S124, when the trigger operation is performed, the image processing unit 12 causes the 4K output to be available. After processes at time t15 and the subsequent times shown in FIG. 15 are performed, the image processing unit 12 outputs various setting screens displayed in step S112. In addition, when there is an stop operation by the user in step S120 or the trigger operation in step S120 has been not performed for a predetermined time, in steps S126, S128, and S206, the image processing system performs processes similar to those at time t15 and the subsequent times shown in FIG. 15.

Subsequently, a process of displaying a one photographic image will be described with reference to the sequence diagram shown in FIG. 18. In step S210, the user switches an input to the video equipment 20 from the image processing device 1 into an HDMI input.

In step S130, the user selects any one of photographic images. In step S132, the image processing unit 12 initiates 4K combining process. Specifically, in step S134, the image processing unit 12 instructs the communication unit 13 to temporarily stop transmitting a TMDS signal. In response to this, the communication unit 13 temporarily stops transmitting the TMDS signal.

In step S212, the pre-processing unit 22 of the video equipment 20 performs an image mute process in response to the temporary stop of the TMDS signal.

In step S136, the image processing unit 12 incorporates output start information into SPD Infoframe and outputs it to the communication unit 13. The communication unit 13 outputs the SPD Infoframe. In step S138, the communication unit 13 resumes the output of the TMDS signal.

In step S140, the image processing unit 12 generates a blank image 700 or an all black image 800 and outputs it to the communication unit 13. The communication unit 13 outputs the blank image 700 or the all black image 800 to the video equipment 20 for the interval of 60V or more. In addition, the communication unit 13 outputs the blank image 700 for the interval of 1V or more before outputting an output image including a reduced image 200. Thus, the image processing device 10 performs a weight process for approximately one second.

On the other hand, in step S214, the video equipment 20 makes preparations for generating a 4K restoration image 500. Specifically, the pre-processing unit 22 waits until the TMDS signal is stabilized. On the other hand, the pre-processing unit 22 performs an image mute process. Further, the pre-processing unit 22 reads SPD Infoframe after the TMDS signal is resumed.

In steps S216 to S218, the pre-processing unit 22 reads the output start information from the SPD Infoframe and performs a signal path switching control (a switching control to be compatible with 4K output) or the like. On other words, the video equipment 20 is changed into 4K combining mode. In addition, the pre-processing unit 22 discards the blank image 700 and the all black image 800. The pre-processing unit 22 may display the all black image 800 on the image output unit 24.

On the other hand, in step S142, the image processing unit 12 acquires a photographic image selected by the user as an input image 100a, and performs the decoding and scaling for the input image 100a. Further, image processing unit 12 generates a 4K original image 100 based on the input image 100a.

In steps S144 to S146, the image processing device 10 performs processes performed in the time intervals from t2 to t8 described above. In other words, the image processing device 10 generates and outputs a reduced image 200, and generates and outputs output images 401 to 412 including divided images 401a to 412a.

On the other hand, in step S220, the communication unit 21 of the video equipment 20 receives the output image including the reduced image 200 and outputs the received output image to the pre-processing unit 22. The pre-processing unit 22 recognizes that the output image is the reduced image 200 based on addition control information 300 in the output image, and outputs the reduced image 200 to the image processing unit 23. The image processing unit 23 detects a facial image from the reduced image 200 and records a color which is included in the facial image in a super-resolution process suppression color table.

Then, in step S222, the communication unit 13 of the video equipment 20 receives the output images 401 to 412 and outputs them to the pre-processing unit 22. The pre-processing unit 22 and the image processing unit 23 generate a 4K original image 500 by performing the above-described process.

In step S224, the image processing unit 23 releases the image mute process and outputs the 4K restoration image 500 to the image output unit 24. The image output unit 24 displays the 4K restoration image 500. Thereafter, when the user selects the second photographic image, processes of step S142 and subsequent steps are repeated. In addition, this process is also applicable to a slide show. In the slide show, the image processing unit 12 selects a photographic image optionally on behalf of the user. Thus, at the timing of switching (a timeout) of each photographic image, processes of step S142 and subsequent steps are repeated.

As described above, according to the present exemplary embodiment, even when the image processing device 10 has only 2K output, the image processing device 10 can output an image with 4K resolution (i.e., a 4K restoration image 500) to the video equipment 20.

Moreover, the image processing system controls by using the SPD Infoframe and video signal (TMSD signal). In other words, the image processing device 10 and the video equipment 20 are connected to each other through a HDMI cable 30, and thus it is not necessary to perform the CEC communication in the present exemplary embodiment.

Furthermore, even when the image processing device 10 may not read EDID information of the video equipment 20 because of other device (e.g., an AV amplifier) disposed between the image processing device 10 and the video equipment 20, the image processing device 10 can determine whether the video equipment 20 is compatible with 4K combining by restoring the description image 600 and thus by performing an authentication process.

In addition, the image processing device 10 outputs the reduced image 200 to the video equipment 20, and thus the video equipment 20 can suppress a super resolution process for a skin color such as a facial color.

Further, the image processing device 10 can determine whether the video equipment 20 is compatible with 4K combining by performing the authentication process, and thus it is possible to reduce a possibility that the divided images 401a to 412a are outputted to the video equipment 20 which is incompatible with 4K combining

Moreover, information indicating whether the video equipment 20 is compatible with 4K combining is included in the EDID information, and thus the image processing device 10 can determine whether the video equipment 20 is compatible with 4K combining

Furthermore, image processing device 10 superimposes the addition control information 300 on a position (near the center of the output image) different from the position on which information is superimposed by other device. Accordingly, it is possible to reduce a possibility that the addition control information 300 is overwritten by information from the other device.

More specifically, the image processing device 10 divides an input image 100a to generate a plurality of divided images 401a to 412a and generates output images 401 to 412 including the divided images 401a to 412a. The image processing device 10 then outputs the output image 401 to 412 to the video equipment 20 which is able to combine the input images 100a. Thus, the video equipment 20 is not necessary to decode the divided images 401a to 412a, and thus it is possible to restore easily the input image 100a. Further, the video equipment 20 combines the divided images 401a to 412a to restore the input image 100a, thereby displaying more various type of images.

Moreover, the image processing device 10 restores the input image 100a by decoding encoding information in which the input image 100a is encoded. Thus, even when the image processing device 10 obtains encoding information, the image processing device 10 can decode the encoding information and output the divided images 401a to 412a. Accordingly, even when the image processing device 10 obtains encoding information, the video equipment 20 is not necessary to include a decoder.

Furthermore, when combining-capable information is included in the EDID information, the image processing device 10 generates the divided images 401a to 412a. Accordingly, it is possible to suppress a possibility that the divided images 401a to 412a are outputted to the video equipment 20 that is incompatible with 4K combining.

In addition, when the image processing device 10 is not able to acquire EDID information, i.e., combining start information from the video equipment 20, the image processing device 10 divides a description image 600 in which a trigger operation is described to generate divided description images 601 to 612. The image processing device 10 generates an output image including the divided description images 601 to 612 and outputs the output image to the video equipment 20. Accordingly, the video equipment 20, when it is compatible with 4K combining, can restore the description image 600 and display it, and thus the user can perform a trigger operation while recognizing the trigger operation. Therefore, the image processing device 10 can determine whether the video equipment 20 is compatible with 4K combining based on the presence or absence of the trigger operation.

Further, the image processing device 10 stops the output of a TMDS signal to the video equipment 20 before outputting the output image 401 to 412 to the video equipment 20, and thus the video equipment 20 can recognize that there is a possibility that the output of output images 401 to 412 is initiated.

Moreover, the image processing device 10 outputs SPD Infoframe including output start information to the video equipment 20 after the output of a TMDS signal is stopped, and thus the video equipment 20 can easily recognize that the output of output images 401 to 412 is initiated.

Furthermore, the image processing device 10 assigns addition control information 300 to the output images 401 to 412, and thus the content of the output image 401 to 412 can be easily understood by the video equipment 20.

In addition, the image processing device 10 generates an output image including a blank image 700, and incorporates addition control information 300 indicating that the output image includes the blank image 700 into the output image. Accordingly, the video equipment 20 can easily understand the fact that the blank image 700 is included in the output image, and thus it is possible to discard easily the blank image 700.

Moreover, the image processing device 10 incorporates a description indicating that the video equipment 20 is incompatible with 4K combining into the blank image 700. On the other hand, if the video equipment 20 is incompatible with 4K combining, the video equipment 20, it may not possible to read the addition control information 300, and thus the blank image 700 is displayed. Accordingly, the user easily understands the fact that the video equipment 20 is incompatible with 4K combining

Furthermore, the image processing device 10 incorporates the second addition control information 302 into the addition control information 300. The second addition control information 302 includes information relevant to the start position and size. Thus, the video equipment 20 can easily restore the input image 100a, specifically, a 4K original image 100 based on the second addition control information 302.

In addition, the image processing device 10 superimposes the addition control information 300 on a position different from the position on which information is superimposed by other device. Accordingly, it is possible to suppress a possibility that the addition control information 300 is overwritten by information from the other device.

Moreover, the video equipment 20 acquires the output images 401 to 412 and extracts divided images, specifically, captured images 501 to 512 from the output images 401 to 412. The video equipment 20 restores the input image 100a by combining the captured images 501 to 512. Accordingly, the video equipment 20 can restore the input image 100a without decoding the output images 401 to 412, and thus the input image 100a can be restored easily.

Furthermore, the video equipment 20 incorporates the combining-capable information into the EDID information and outputs it to the image processing device 10. Accordingly, the image processing device 10 can easily determine whether the video equipment 20 is compatible with 4K combining

In addition, when the video equipment 20 receives the output image including the divided description images 601 to 612, the video equipment 20 extracts the divided description images 601 to 612 from the output image and combines the divided description images 601 to 612, thereby restoring the description image 600. Accordingly, if the video equipment 20 is compatible with 4K combining, it is possible to display the description image 600, and thus the user can perform a trigger operation.

Moreover, when the output of TMDS signal is stopped, the video equipment 20 checks the content of SPD Infoframe outputted after the output of TMDS signal is resumed. Accordingly, it is possible to easily determine whether the output of divided images 401a to 412a is initiated.

Furthermore, the video equipment 20 performs a process based on the addition control information, and thus it is possible to perform the process for the output image more accurately.

It should be understood by those skilled in the art that various modifications, combinations, sub-combinations and alterations may occur depending on design requirements and other factors insofar as they are within the scope of the appended claims or the equivalents thereof.

For example, in the present exemplary embodiment, the video equipment 20 displays the 4K original image 500. However, the present technology is not limited to this example. For example, the video equipment 20 may be configured to output a 4K restoration image to other device. In addition, the resolution of an output image is not limited to 2K, and the resolution of 4K original image and resolution image are not limited to 4K.

Additionally, the present technology may also be configured as below:

(1) An image processing device including:

an image processing unit configured to divide an input image, to generate a plurality of divided images, and to generate an output image which includes the divided images; and

a communication unit configured to output the output image to a second image processing device adapted to be able to restore the input image by combining the divided images.

(2) The image processing device according to (1), wherein the image processing unit restores the input image by decoding encoding information in which the input image is encoded.

(3) The image processing device according to (1) or (2), wherein the image processing unit generates the divided images when the image processing unit receives combining-capable information indicating that the second image processing device is compatible with combining of the divided images from the second image processing device.

(4) The image processing device according to (3), wherein, when the combining-capable information is unobtainable from the second image processing device, the image processing unit divides an description image in which a trigger operation is described to generate divided description images and incorporates the divided description images into the output image, the trigger operation being necessary to start generating the divided images.

(5) The image processing device according to any one of (1) to (4), wherein the communication unit stops outputting information to the second image processing device before outputting the output image to the second image processing device.

(6) The image processing device according to (5), wherein the communication unit outputs output start information to the second image processing device after the communication unit stops outputting a information to the second image processing device, the output start information indicating that output of the output image is started.

(7) The image processing device according to any one of (1) to (6), wherein the image processing unit assigns addition control information to the output image, the addition control information being relevant to the output image.

(8) The image processing device according to (7), wherein the image processing unit incorporates an unavailable image which is not to be outputted by the second image processing device into the output image and incorporates information indicating that the output image contains the unavailable image into the addition control information.

(9) The image processing device according to (8), wherein the image processing unit incorporates information indicating that the second image processing device is incompatible with combining of the divided images into the unavailable image.

(10) The image processing device according to any one of (7) to (9), wherein the image processing unit reserves a memory region corresponding to the input image, generates an original image by attaching the input image to the memory region, generates the divided images by dividing the original image, and incorporates information indicating a position of the input image in the original image and a size of the input image into the addition control information.

(11) The image processing device according to any one of (7) to (10),

wherein the output image has information superimposed thereon by other equipment, and

wherein the image processing unit superimposes the addition control information at a position different from a position at which the other equipment superimposes information.

(12) An image processing device including:

a communication unit configured to divide an input image to generate a plurality of divided images, to incorporate the divided images, and to obtain the output image from a second image processing device, the second image processing device being adapted to generate the output image with a first resolution, and

an image processing unit configured to extract the divided images from the output image, to combine the divided images, and to restore the input image.

(13) The image processing device according to (12), wherein the communication unit outputs combining-capable information indicating that it is possible to be compatible with combining of the divided images to the second image processing device.

(14) The image processing device according to (12) or (13),

wherein the second image processing device divides a description image in which a trigger operation is described to generate divided description images and incorporates the divided description image into the output image, the trigger operation being necessary to start generating the divided images, and

wherein the image processing unit extracts the divided description images from the output image and combines the divided description images to restore the description image.

(15) The image processing device according to any one of (12) to (14),

wherein, before outputting the output image to the communication unit, the second image processing device stops outputting information to the communication unit and outputs output start information to the communication unit, the output start information indicating that output of the output image is started, and

wherein, when output of information to the communication unit is stopped, the image processing unit checks a content of the output start information which is outputted after the output of information to the communication unit is stopped.

(16) The image processing device according to any one of (12) to (15),

wherein the second image processing device assigns addition control information to the output image, the addition control information being relevant to the output image, and

wherein the image processing unit performs a process based on the addition control information.

(17) An image processing method including:

dividing an input image to generate a plurality of divided images and generating an output image which includes the divided images; and

outputting the output image to a second image processing device adapted to be able to restore the input image by combining the divided images.

(18) An image processing method including:

dividing an input image to generate a plurality of divided images and obtaining an output image from a second image processing device adapted to generate the output image which includes the divided images; and

extracting the divided images from the output image and combining the divided images to restore the input image.

(19) A program that causes a computer to implement:

an image processing function of dividing an input image to generate a plurality of divided images and generating an output image which includes the divided images; and

a communication function of outputting the output image to a second image processing device adapted to be able to restore the input image by combining the divided images.

(20) A program that causes a computer to implement:

a communication function of dividing an input image to generate a plurality of divided images and obtaining an output image from a second image processing device adapted to generate the output image which includes the divided images; and

an image processing function of extracting the divided images from the output image and combining the divided images to restore the input image.

The present disclosure contains subject matter related to that disclosed in Japanese Priority Patent Application JP 2012-183118 filed in the Japan Patent Office on Aug. 22, 2012, the entire content of which is hereby incorporated by reference.

What is claimed is:

1. An image processing device comprising:
an image processing unit configured to divide an input image, to generate a plurality of divided images, and to generate an output image which includes the divided images; and
a communication unit configured to output the output image to a second image processing device adapted to be able to restore the input image by combining the divided images.

2. The image processing device according to claim 1, wherein the image processing unit restores the input image by decoding encoding information in which the input image is encoded.

3. The image processing device according to claim 1, wherein the image processing unit generates the divided images when the image processing unit receives combining-capable information indicating that the second image processing device is compatible with combining of the divided images from the second image processing device.

4. The image processing device according to claim 3, wherein, when the combining-capable information is unobtainable from the second image processing device, the image processing unit divides an description image in which a trigger operation is described to generate divided description images and incorporates the divided description images into the output image, the trigger operation being necessary to start generating the divided images.

5. The image processing device according to claim 1, wherein the communication unit stops outputting information to the second image processing device before outputting the output image to the second image processing device.

6. The image processing device according to claim 5, wherein the communication unit outputs output start information to the second image processing device after the communication unit stops outputting a information to the second image processing device, the output start information indicating that output of the output image is started.

7. The image processing device according to claim 1, wherein the image processing unit assigns addition control information to the output image, the addition control information being relevant to the output image.

8. The image processing device according to claim 7, wherein the image processing unit incorporates an unavailable image which is not to be outputted by the second image processing device into the output image and incorporates information indicating that the output image contains the unavailable image into the addition control information.

9. The image processing device according to claim 8, wherein the image processing unit incorporates information indicating that the second image processing device is incompatible with combining of the divided images into the unavailable image.

10. The image processing device according to claim 7, wherein the image processing unit reserves a memory region corresponding to the input image, generates an original image by attaching the input image to the memory region, generates the divided images by dividing the original image, and incorporates information indicating a position of the input image in the original image and a size of the input image into the addition control information.

11. The image processing device according to claim 7,
wherein the output image has information superimposed thereon by other equipment, and
wherein the image processing unit superimposes the addition control information at a position different from a position at which the other equipment superimposes information.

12. An image processing device comprising:
a communication unit configured to divide an input image to generate a plurality of divided images, to incorporate the divided images, and to obtain the output image from a second image processing device, the second image processing device being adapted to generate the output image with a first resolution, and
an image processing unit configured to extract the divided images from the output image, to combine the divided images, and to restore the input image.

13. The image processing device according to claim 12, wherein the communication unit outputs combining-capable information indicating that it is possible to be compatible with combining of the divided images to the second image processing device.

14. The image processing device according to claim 12,
wherein the second image processing device divides a description image in which a trigger operation is described to generate divided description images and incorporates the divided description image into the output image, the trigger operation being necessary to start generating the divided images, and
wherein the image processing unit extracts the divided description images from the output image and combines the divided description images to restore the description image.

15. The image processing device according to claim 12,
wherein, before outputting the output image to the communication unit, the second image processing device stops outputting information to the communication unit and outputs output start information to the communication unit, the output start information indicating that output of the output image is started, and
wherein, when output of information to the communication unit is stopped, the image processing unit checks a content of the output start information which is outputted after the output of information to the communication unit is stopped.

16. The image processing device according to claim 12,
wherein the second image processing device assigns addition control information to the output image, the addition control information being relevant to the output image, and
wherein the image processing unit performs a process based on the addition control information.

17. An image processing method comprising:
dividing an input image to generate a plurality of divided images and generating an output image which includes the divided images; and
outputting the output image to a second image processing device adapted to be able to restore the input image by combining the divided images.

18. An image processing method comprising:
dividing an input image to generate a plurality of divided images and obtaining an output image from a second image processing device adapted to generate the output image which includes the divided images; and
extracting the divided images from the output image and combining the divided images to restore the input image.

19. A program that causes a computer to implement:
an image processing function of dividing an input image to generate a plurality of divided images and generating an output image which includes the divided images; and
a communication function of outputting the output image to a second image processing device adapted to be able to restore the input image by combining the divided images.

20. A program that causes a computer to implement:
a communication function of dividing an input image to generate a plurality of divided images and obtaining an output image from a second image processing device adapted to generate the output image which includes the divided images; and
an image processing function of extracting the divided images from the output image and combining the divided images to restore the input image.
